(19) United States
(12) Patent Application Publication
(10) Pub. No.: US 2026/0296938 A1
(43) Pub. Date: Oct. 1, 2026

(54) CONTROLLED FLOW BAFFLES FOR A TREATMENT TANK

(71) Applicant: Parkson Corporation, Fort Lauderdale, FL (US)

(72) Inventors: Michael P. Sargent, Denver, CO (US); John M. Kearney, Arlington Heights, IL (US); Thomas E. Coleman, Yakima, WA (US)

(73) Assignee: Parkson Corporation, Fort Lauderdale, FL (US)

(21) Appl. No.: 19/635,387

(22) Filed: Mar. 31, 2026

Related U.S. Application Data
(60) Provisional application No. 64/022,132, filed on Mar. 30, 2026.
(60) Provisional application No. 63/781,089, filed on Mar. 31, 2025.

(51) Int. Cl. C02F 3/30; C02F 3/00

(52) U.S. Cl. CPC C02F 3/301; C02F 2003/008; C02F 2203/006

(57) ABSTRACT

A controlled flow baffle in a treatment tank for water or wastewater treatment includes an opening defined within a surface of the controlled flow baffle, where the opening is operable to allow water or wastewater to flow between adjacent zones defined by the controlled flow baffle in the treatment tank. The controlled flow baffle includes an actuation element able to adjust a size of the opening and/or adjust a height of a weir. Increasing the size of the opening increases a flow of the water or wastewater through the opening and decreases an elevation of a weir crest of the water or wastewater flowing over the controlled flow baffle. Decreasing the size of the opening decreases the flow of the water or wastewater through the opening and increases the elevation of the weir crest of the water or wastewater flowing over the controlled flow baffle.

### CROSS-REFERENCE TO RELATED APPLICATION

The present application claims the benefit of priority under 35 U.S.C. § 119(e) to U.S. Provisional Patent Application No. 64/022,132, filed on Mar. 30, 2026, and to U.S. Provisional Patent Application No. 63/781,089, filed on Mar. 31, 2025, the entirety of each of which is incorporated herein by reference.

### FIELD

The present disclosure is directed to water and wastewater treatment and, in particular, to controlled flow baffles that separate a cavity defined within a treatment tank into zones for a water or wastewater treatment process.

### BACKGROUND

The background description includes information that may be useful in understanding the present inventive subject matter. It is not an admission that any of the information provided herein is prior art or relevant to the presently claimed disclosure, or that any publication specifically or implicitly referenced is prior art.

Select water and wastewater treatment systems utilize water or wastewater treatment processes such as activated sludge processes, densified sludge processes, granular activated sludge processes, and the like. To assist in performing these processes, the water and wastewater treatment systems include treatment basins or tanks or other containment structures, hereinafter referred to as tank or tanks, that may be compartmentalized into zones with baffles. With the compartmentalizing, flow travels across the multiple treatment zones as part of a larger treatment process.

In some examples, the compartmentalized zones within the treatment tank may include anaerobic zones, aerobic zones, anoxic zones, oxic zones, mixed zones, unmixed zones, and any combination thereof. The multiple zones may be utilized to create environments that will biologically achieve removal of any combination of phosphorous, nitrogen, and/or organic contaminants.

In some instances, processes utilized by water treatment systems (e.g., potable water treatment applications) benefit from a controlled weir crest elevation over, under, and/or around a baffle. Where parameters (e.g., zone sizes such as width, length, and/or depth, height of baffle, flow rates between zones, and the like) between the various zone differ within the treatment tank, however, this controlled weir crest can be difficult to achieve.

### SUMMARY

Accordingly, there exists a long-felt but unmet need to improve upon water and wastewater treatment systems. In particular, improvements of the present disclosure are directed to a treatment tank with controlled flow baffles that define zones within a treatment tank for various stages of a treatment process. The controlled flow baffles include actuation elements (e.g., covers, shutters, dampers, gates, or the like) which may be opened and closed to regulate and control a weir crest over the controlled flow baffles and between the zones to provide required or desired physical or capacity overflow, underflow, through flow or bypass characteristics.

Embodiments of the present disclosure are directed to a treatment tank with controlled flow baffles. The controlled flow baffles are utilized to separate a treatment tank into compartments or zones. A flow of water or wastewater travels across the controlled flow baffle and between the compartments or zones as part of a treatment process, between an inlet and an outlet of the treatment tank.

In embodiments, the actuation elements of the controlled flow baffles open and close openings or ports in the controlled flow baffles, to allow a portion of the flow to pass through the openings in the controlled flow baffles below the water surface (subsurface). In some configurations, the rate of water flowing over the top of the baffle may be inversely proportional to the rate of water flowing through the actuation elements. Controlling the actuation elements of the controlled flow baffles assists in maintaining a controlled weir crest of water flowing over the top of the baffle (above-surface). For example, altering a position of an actuation element to increase the size of the opening increases subsurface flow, reducing the elevation of the weir crest over the controlled flow baffle. By way of another example, altering the position of the actuation element to decrease the size of the opening reduces subsurface flow, increasing the elevation of the weir crest over the controlled flow baffle.

In embodiments, one or more actuation elements of the controlled flow baffles may be positioned at or near the top of the controlled flow baffle, and may be adjusted to reduce the weir crest to be at or below the elevation of the liquid surface.

In embodiments, the actuation elements of the controlled flow baffles may be driven by a control mechanism for controlling liquid flow and/or level. The control mechanism controlling the controlled flow baffles allows the subsurface flow profile to vary as the flow of fluid enters into the treatment tank (and/or entering into a particular zone for a particular stage of the treatment process) varies. As such, the control mechanism also assists in maintaining a controlled weir crest elevation over the top of the controlled flow baffles between zones.

In one example, such as during low flow conditions, the control mechanism drives the actuation elements of the controlled flow baffles such that openings in the controlled flow baffles are closed (or only partially opened), to maintain a desired crest elevation over the top of the controlled flow baffle. In another example, such as during high flow conditions, the control mechanism drives the actuation elements of the controlled flow baffles such that the openings in the controlled flow baffles are mostly (or fully) opened, allowing for a proportionately higher volume of the fluid flow to pass through the subsurface openings while still maintaining the controlled weir crest elevation over the top of the controlled flow baffles at a similar elevation to that achieved during lower flow conditions.

The control mechanism may use manual means, automatic means, or a combination of both when adjusting subsurface flow through (and over, under, and/or around) the controlled flow baffles. For example, the control mechanism may be manual and operated by a user monitoring operational parameters such as the flow into, within, and out of the treatment tank. By way of another example, the control mechanism may be automatic and operated by a controller monitoring operational parameters such as the flow into, within, and out of the treatment tank and/or the level of fluid in and upstream and downstream or the treatment tank. By way of another example, the control mechanism may include a manually-adjusted control mechanism that is utilized in combination with an automatic means of control.

Automatic subsurface control for fluid flow and/or level may be achieved by any method or process that automatically adjusts the volume of fluid flow passing through the openings or ports (and over, under, and/or around the controlled flow baffles) within the controlled flow baffles. For example, these changes may be made in response to changes in upstream hydraulic head that are created by changes in head, and/or volumetric flow influent to the controlled flow baffles. In some configurations, the control mechanism automatically compensates for the changes in upstream hydraulics so that the weir crest elevation over the top of the controlled flow baffles remains controlled during all flow conditions (and/or remains at a desired flow condition as utilized for a particular treatment process and/or stage of the treatment process within or across a particular zone or from one zone to another).

In embodiments, actuation elements of the controlled flow baffles may be passively driven by the forces associated with flow-induced head loss, buoyancy forces, or other means not requiring actuation by operator or controller by active means of control (e.g., automatic and/or manual means), either in addition to or instead of the active means of control driven by manual or automatic processes. The passive or active means of control may be mechanical, electromechanical, electrical, hydraulic, or pneumatic in nature. Alternatively, or in addition, the passive or active means of control may be based on buoyancy of an actuation element, and/or a flow element of a controlled flow baffle.

In embodiments, the means of control may include, but are not limited to, adjustable flow flaps, heart valve flap valves, buoyant flap valves, smooth weir transition elements, adjustable weir elements, swing away baffles, and/or flow balance weirs and orifices. In embodiments, the means of control for actuating an orifice gate (or, more generally, an actuation element) may include, but are not limited to, one or more of a cable-actuated float, a powered or manual mechanical actuator, an underwater velocity-driven sail, a pneumatic (e.g., gas-driven) or hydraulic (e.g., fluid-driven) pressurized cylinder, a rubber flap, and/or a biasing element. The exemplary means of control described throughout the present disclosure are individually usable or combinable together for controlling actuation elements of flow baffles.

It is contemplated that, in some configurations, a ratio for the orifice gate (or, more generally, the actuation element) to orifice area may range between approximately 0.05 pounds (lbs) per square inch (psi) and 2 psi for a gate which may optionally be weighted.

A first aspect of the present disclosure is to provide a controlled flow baffle in a treatment tank for water or wastewater treatment. The controlled flow baffle includes an opening defined within a surface of the controlled flow baffle, the opening operable to allow water or wastewater to flow between adjacent zones defined by the controlled flow baffle in the treatment tank. The controlled flow baffle includes an actuation element able to adjust a size of the opening. Increasing the size of the opening by actuating the actuation element increases a flow of the water or wastewater through the opening and decreases an elevation of a weir crest of the water or wastewater flowing over the controlled flow baffle. Decreasing the size of the opening by actuating the actuation element decreases the flow of the water or wastewater through the opening and increases an elevation of the weir crest of the water or wastewater flowing over the controlled flow baffle.

The controlled flow baffle of the first aspect may include, optionally, that the actuation element is controlled through electronic actuation of a servo coupled to the actuation element.

The controlled flow baffle of the first aspect may include one or more of the previous embodiments and, optionally, that the servo is in communication with a control unit of a control system.

The controlled flow baffle of the first aspect may include one or more of the previous embodiments and, optionally, that the servo is automatically operated by the control unit of the control system in response to data received from sensors in the treatment tank.

The controlled flow baffle of the first aspect may include one or more of the previous embodiments and, optionally, that the servo is operated following a user input to the control system by a user.

The controlled flow baffle of the first aspect may include one or more of the previous embodiments and, optionally, that the actuation element is controlled through actuation of mechanical assemblies coupled to the actuation element.

The controlled flow baffle of the first aspect may include one or more of the previous embodiments and, optionally, that the actuation of the mechanical assemblies is automatically operated by a control unit of a control system.

The controlled flow baffle of the first aspect may include one or more of the previous embodiments and, optionally, that the actuation of the mechanical assemblies is manually operated by a user.

The controlled flow baffle of the first aspect may include one or more of the previous embodiments and, optionally, that the actuation element is passively controlled by forces associated with flow-induced head loss, buoyancy forces, or other means not requiring actuation by operator or controller.

The controlled flow baffle of the first aspect may include one or more of the previous embodiments and, optionally, includes an actuation element positioned proximate to a top edge or surface of the controlled flow baffle for increasing or reducing a weir crest for the controlled flow baffle to above, at, or below the elevation of the liquid surface.

A second aspect of the present disclosure is to provide a treatment system for water or wastewater treatment. The treatment system includes a treatment tank. The treatment tank includes an inlet able to receive water or wastewater in need of treatment. The treatment tank includes an outlet able to provide treated water or wastewater. The treatment tank includes a controlled flow baffle between the inlet and the outlet. The controlled flow baffle includes an opening defined within a surface of the controlled flow baffle, the opening operable to allow received water or wastewater to flow between adjacent zones defined by the controlled flow baffle in the treatment tank. The controlled flow baffle includes an actuation element able to adjust a size of the opening. Increasing the size of the opening by actuating the actuation element increases a flow of the received water or wastewater through the opening and decreases an elevation of a weir crest of the water or wastewater flowing over the controlled flow baffle. Decreasing the size of the opening by actuating the actuation element decreases the flow of the received water or wastewater through the opening and increases an elevation of the weir crest of the water or wastewater flowing over the controlled flow baffle.

The treatment system of the second aspect may include, optionally, a control system operable to control the actuation element to adjust the size of the opening, that the control system includes a control unit in communication with a servo coupled to the actuation element.

The treatment system of the second aspect may include one or more of the previous embodiments and, optionally, a sensor within the treatment tank to monitor operational parameters within the treatment tank, that data from the sensors is provided to the control unit of the control system.

The treatment system of the second aspect may include one or more of the previous embodiments and, optionally, that, based on the data from the sensor, the control unit automatically controls a position of the actuation element via control of the servo.

The treatment system of the second aspect may include one or more of the previous embodiments and, optionally, that the servo is operated following a user input to the control system by a user.

The treatment system of the second aspect may include one or more of the previous embodiments and, optionally, that the actuation element is controlled through actuation of mechanical assemblies coupled to the actuation element.

The treatment system of the second aspect may include one or more of the previous embodiments and, optionally, that the actuation of the mechanical assemblies is automatically operated by a control unit of a control system.

The treatment system of the second aspect may include one or more of the previous embodiments and, optionally, that the actuation of the mechanical assemblies is manually operated by a user.

The treatment system of the second aspect may include one or more of the previous embodiments and, optionally, that the actuation element is passively controlled by forces associated with flow-induced head loss, buoyancy forces, or other means not requiring actuation by operator or controller.

The treatment system of the second aspect may include one or more of the previous embodiments and, optionally, that the controlled flow baffle further includes an actuation element positioned proximate to a top edge or surface of the controlled flow baffle for increasing or reducing a weir crest for the controlled flow baffle to above, at, or below the elevation of the liquid surface.

A third aspect of the present disclosure is to provide a method. The method may include, but is not limited to, providing a treatment tank for water or wastewater treatment, where the treatment tank includes a controlled flow baffle. The method may include, but is not limited to, receiving water or wastewater in need of treatment within the treatment tank. The method may include, but is not limited to, passing the water or wastewater through stages of a treatment process. The method may include, but is not limited to, monitoring a weir crest of the water or wastewater flowing over the controlled flow baffle. The method may include, but is not limited to, providing treated water or wastewater from the treatment tank.

The method of the third aspect may include, optionally, increasing a size of an opening in a surface of the controlled flow baffle by adjusting an actuation element when an elevation of the weir crest exceeds a pre-determined threshold, to decrease the elevation of the weir crest.

The method of the third aspect may include one or more of the previous embodiments and, optionally, decreasing a size of an opening in a surface of the controlled flow baffle by adjusting an actuation element when an elevation of the weir crest is below a pre-determined threshold, to increase the elevation of the weir crest.

The method of the third aspect may include one or more of the previous embodiments and, optionally, adjusting a height of a surface weir by adjusting an actuation element when an elevation of the weir crest is below a pre-determined threshold or exceeds a pre-determined threshold.

The method of the third aspect may include one or more of the previous embodiments and, optionally, that the adjusting of the actuation element is automatically performed by a control unit in communication with a servo coupled to the actuation element based on data received from sensors that monitor the weir crest over the controlled flow baffle.

The method of the third aspect may include one or more of the previous embodiments and, optionally, that the adjusting of the actuation element is passively controlled by forces associated with flow-induced head loss, buoyancy forces, or other means not requiring actuation by operator or controller.

A fourth aspect of the present disclosure is to provide a controlled flow baffle in a treatment tank for water or wastewater treatment. The controlled flow baffle includes an opening defined within a surface of the controlled flow baffle, the opening operable to allow water or wastewater to flow between adjacent zones defined by the controlled flow baffle in the treatment tank. The controlled flow baffle includes an actuation element able to adjust a size of the opening. Increasing the size of the opening by actuating the actuation element increases a flow of the water or wastewater through the opening and decreases an elevation of a weir crest of the water or wastewater flowing over the controlled flow baffle. Decreasing the size of the opening by actuating the actuation element decreases the flow of the water or wastewater through the opening and increases the elevation of the weir crest of the water or wastewater flowing over the controlled flow baffle.

The controlled flow baffle of the fourth aspect may include, optionally, that the actuation element is passively controlled by forces associated with flow-induced head loss, buoyancy forces, or other non-actively controlled means.

The controlled flow baffle of the fourth aspect may include one or more of the previous embodiments and, optionally, that a configuration of the actuation element adjusts in response to a change in liquid surface height within the treatment tank.

The controlled flow baffle of the fourth aspect may include one or more of the previous embodiments and, optionally, that a configuration of the actuation element adjusts in response to a change in flow rate through the treatment tank.

The controlled flow baffle of the fourth aspect may include one or more of the previous embodiments and, optionally, a flow element positioned proximate to a top edge or surface of the controlled flow baffle for increasing or reducing a weir crest for the controlled flow baffle.

The controlled flow baffle of the fourth aspect may include one or more of the previous embodiments and, optionally, that the flow element is a static flow element.

The controlled flow baffle of the fourth aspect may include one or more of the previous embodiments and, optionally, that the flow element is passively controlled by forces associated with flow-induced head loss, buoyancy forces, or other non-actively controlled means.

The controlled flow baffle of the fourth aspect may include one or more of the previous embodiments and, optionally, that a configuration of the flow element adjusts in response to a change in liquid surface height within the treatment tank.

The controlled flow baffle of the fourth aspect may include one or more of the previous embodiments and, optionally, that a configuration of the flow element adjusts in response to a change in flow rate through the treatment tank.

A fifth aspect of the present disclosure is to provide a treatment system for water or wastewater treatment. The treatment system includes a treatment tank. The treatment tank includes an inlet able to receive water or wastewater in need of treatment. The treatment tank includes an outlet able to provide treated water or wastewater. The treatment tank includes a controlled flow baffle between the inlet and the outlet. The controlled flow baffle includes an opening defined within a surface of the controlled flow baffle, the opening operable to allow received water or wastewater to flow between adjacent zones defined by the controlled flow baffle in the treatment tank. The controlled flow baffle includes an actuation element able to adjust a size of the opening. Increasing the size of the opening by actuating the actuation element increases a flow of the received water or wastewater through the opening and decreases an elevation of a weir crest of the water or wastewater flowing over the controlled flow baffle. Decreasing the size of the opening by actuating the actuation element decreases the flow of the received water or wastewater through the opening and increases the elevation of the weir crest of the water or wastewater flowing over the controlled flow baffle.

The treatment system of the fifth aspect may include, optionally, a control system and a sensor within the treatment tank to monitor operational parameters within the treatment tank. Data from the sensor is provided to a control unit of the control system.

The treatment system of the fifth aspect may include one or more of the previous embodiments and, optionally, that the actuation element is passively controlled by forces associated with flow-induced head loss, buoyancy forces, or other means not requiring actuation by a user or a control system.

The treatment system of the fifth aspect may include one or more of the previous embodiments and, optionally, that a configuration of the actuation element adjusts in response to a change in liquid surface height within the treatment tank.

The treatment system of the fifth aspect may include one or more of the previous embodiments and, optionally, that a configuration of the actuation element adjusts in response to a change in flow rate through the treatment tank.

The treatment system of the fifth aspect may include one or more of the previous embodiments and, optionally, that the controlled flow baffle further includes a flow element positioned proximate to a top edge or surface of the controlled flow baffle for increasing or reducing a weir crest for the controlled flow baffle.

The treatment system of the fifth aspect may include one or more of the previous embodiments and, optionally, that the flow element is a static flow element.

The treatment system of the fifth aspect may include one or more of the previous embodiments and, optionally, that the flow element is passively controlled by forces associated with flow-induced head loss, buoyancy forces, or other non-actively controlled means.

The treatment system of the fifth aspect may include one or more of the previous embodiments and, optionally, that a configuration of the flow element adjusts in response to a change in liquid surface height within the treatment tank.

The treatment system of the fifth aspect may include one or more of the previous embodiments and, optionally, that a configuration of the flow element adjusts in response to a change in flow rate through the treatment tank.

A sixth aspect of the present disclosure is to provide a controlled flow baffle in a treatment tank for water or wastewater treatment. The controlled flow baffle includes an opening defined within a surface of the controlled flow baffle, the opening operable to allow water or wastewater to flow between adjacent zones of the treatment tank defined by the controlled flow baffle. The controlled flow baffle includes an actuation element able to adjust a size of the opening. The actuation element is passively controlled by forces associated with flow-induced head loss, buoyancy forces, or other non-actively controlled means. The controlled flow baffle includes a flow element positioned proximate to a top edge or surface of the controlled flow baffle for increasing or reducing a height of a weir crest for the controlled flow baffle.

The phrases “at least one”, “one or more”, and “and/or”, as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and claims are to be understood as being modified in all instances by the term “about” or “approximately”. As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

The use of “substantially” in the present disclosure, when referring to a measurable quantity (e.g., a diameter or other distance) and used for purposes of comparison, is intended to mean within 5% of the comparative quantity. The terms “substantially similar to,” “substantially the same as,” and “substantially equal to,” as used herein, should be interpreted as if explicitly reciting and encompassing the special case in which the items of comparison are “similar to,” “the same as” and “equal to,” respectively.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein. The use of “engaged with” and variations thereof herein is meant to encompass any direct or indirect connections between components.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description, Abstract, and claims themselves.

These and other advantages will be apparent from the disclosure of the invention(s) contained herein. The above-described embodiments, objectives, and configurations are neither complete nor exhaustive. The Summary is neither intended nor should it be construed as being representative of the full extent and scope of the present disclosure. Moreover, references made herein to “the present disclosure” or aspects thereof should be understood to mean certain embodiments of the present disclosure and should not necessarily be construed as limiting all embodiments to a particular description. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more readily apparent from the Detailed Description, particularly when taken together with the drawings.

It is to be appreciated that any feature or aspect described herein can be claimed in combination with any other feature(s) or aspect(s) as described herein, regardless of whether the features or aspects come from the same described embodiment.

Any one or more aspects described herein can be combined with any other one or more aspects described herein. Any one or more features described herein can be combined with any other one or more features described herein. Any one or more embodiments described herein can be combined with any other one or more embodiments described herein.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure and is not meant to limit the inventive concepts disclosed herein.

The accompanying drawings, which are incorporated in and constitute a part of the specification, illustrate embodiments of the disclosure and together with the general description of the disclosure given above and the detailed description of the drawings given below, serve to explain the principles of the disclosure.

FIG. 1 is a top plan view of a treatment tank with controlled flow baffles, in accordance with one or more embodiments of the present disclosure;

FIG. 2 is a side elevation view of the treatment tank with the controlled flow baffles of FIG. 1, where the controlled flow baffles include actuation elements, in accordance with one or more embodiments of the present disclosure;

FIG. 3 is an example of a treatment process within a treatment tank with the controlled flow baffles of FIG. 1, in accordance with one or more embodiments of the present disclosure;

FIG. 4 is an example of a treatment process within a treatment tank with the controlled flow baffles of FIG. 1, in accordance with one or more embodiments of the present disclosure;

FIG. 5 is an example of a treatment process within a treatment tank with the controlled flow baffles of FIG. 1, in accordance with one or more embodiments of the present disclosure;

FIG. 6 is a process flow diagram for using the treatment tank with the controlled flow baffles of FIG. 1, in accordance with one or more embodiments of the present disclosure;

FIGS. 7A – 7B generally illustrate a variation of an actuation element of FIG. 2 including an adjustable flow flap gate;

FIGS. 8A – 8D generally illustrate a variation of an actuation element of FIG. 2 including a flap valve;

FIGS. 9A – 9F generally illustrate a variation of an actuation element of FIG. 3 including a buoyant flap valve;

FIG. 10 illustrates variations of a backing plate for the actuation element of FIGS. 8A – 8D and/or the actuation element of FIGS. 9A – 9F;

FIG. 11A – 11B illustrate variations of a static configuration for the flow element of FIG. 2 that is couplable to the controlled flow baffle of FIG. 2;

FIG. 12A-12C illustrate variations of a shaped proximal portion of the controlled flow baffle of FIG. 2, including optional variations of the static configuration for the flow element of FIG. 2 that is couplable to the controlled flow baffle of FIG. 2;

FIGS. 13A – 13O illustrate variations of an adjustable flow element of FIG. 2 that is couplable to the controlled flow baffle of FIG. 2;

FIGS. 14A – 14C illustrate a variation of the flow element of FIG. 2 including a swing baffle;

FIG. 15 illustrates a variation of the flow element and the actuation element of FIG. 2 including a flow balance weir and orifice; and

FIG. 16A and 16B illustrate schematic diagrams of forces of a flap valve used as an actuation element in FIG. 2.

It should be understood that the drawings are not necessarily to scale, and various dimensions may be altered. In certain instances, details that are not necessary for an understanding of the disclosure or that render other details difficult to perceive may have been omitted. It should be understood, of course, that the disclosure is not necessarily limited to the particular embodiments illustrated herein. It is noted that any line in the drawings may be illustrated as solid or broken lines, including any section or length of each individual line, without departing from the scope of the present disclosure.

It will be appreciated that recitation of, for example, reference character 117, 117A, 117B, etc. may apply to any combination of reference characters 117, 117A, 117B, etc. In addition, it will be appreciated any reference characters “xx01”, “01”, and “1”, etc. within the figures and the description are referring to the same component within a system or operation of a method.

### REFERENCE NUMERAL NAME

100 Treatment System

102 Treatment Tank

104 Wall or Boundary of Treatment Tank

106 Cavity

108 Inlet

110 Outlet

112, 112A – 112D Zone

114, 114A – 114C Controlled Flow Baffle

116, 116A – 116C Surface

200, 200A – 200D Actuation Element

201 Flow Element Proximate to Top of Weir

202A – 202C Flow Through Baffle Port or Opening

204A – 204C Opening or Port

206A – 206C Weir Crest

208 Bottom

210, 210A – 210C Control Mechanism

211 Control Mechanism

212 Control System

214, 214A – 214F Sensors

216 Control Unit

218 Processors

220 Memory

222 User Interface

224 Transmitters and Receivers

300 Wastewater Treatment Process

302 Anaerobic Stage

304 Anoxic Stage

306 Aerobic Stage

308, 308A – 308E Zone

310, 310A – 310D Controlled Flow Baffle

400 Wastewater Treatment Process

402 Anaerobic Stage

404 Anaerobic/Anoxic Stage

406 Anoxic/Oxic Swing Zone Stage

408 Oxic Stage

410, 410A – 410H Zone

412, 412A – 412G Controlled Flow Baffle

414 Divider

416 Physical Wall

500 Water Treatment Process

502, 502A – 502D Zone

504, 504A – 504C Controlled Flow Baffle

506 Flocculation Stage

508 Sedimentation Stage

600 Method or Process

602 Provide Controlled Flow Baffles for a Treatment Tank

604 Receive Water or Wastewater

606 Pass Water or Wastewater Through Stages of Treatment Process

608 Monitor Weir Crest Over Controlled Flow Baffles

610 Increase Opening Size in Controlled Flow Baffle

612 Decrease Opening Size in Controlled Flow Baffle

614 Adjust Height of Surface Weir

616 Provide Treated Water or Wastewater

700 Actuation Element

702 Flow through Baffle Port or Opening

704 Opening or Port

706A, 706B Float

708 Pivot Arm

710A, 710B Connector

712A, 712B Stand

714 Member

716 Collar

718 Linkage Assembly

720 Linkage

722 Bracket

724 Pivot

800A, 800B Actuation Element

802A, 802B Flapper

804A, 804B Backing Plate

806 Slots

808 Flaps

810 Apertures

812A, 812B Cutout

814A, 814B Mounting Aperture

816 Apertures

818 Dividers

900A – 900D Actuation Element

902 Flapper

904 Backing Plate

906A – 906D Buoyant Core

908 Crease Region

910 Cutout

912 Divider

914 Mounting Aperture

1000A – 1000I Backing Plate

1002 Cutout

1004 Divider

1100A – 1100G Flow Element

1102 Transition

1104 Pre-Transition Portion

1106 Post-Transition Portion

1108 Brace

1110 Proximal End of Controlled Flow Baffle

1112 Opening

1114 Basin

1116 Channel

1200A – 1200C Proximal End of Controlled Flow Baffle

1202A – 1202G Flow Element

1204 Transition

1206 Pre-Transition Portion

1208 Post-Transition Portion

1210 Transition

1212 Pre-Transition Portion

1214 Post-Transition Portion

1300A – 1300N Adjustable Flow Element

1302 Transition

1304 Pre-Transition Portion

1306 Post-Transition Portion

1308 Primary Section

1309 Secondary Section

1310 Hinge

1312 Float

1314 Hinge

1316 Stand

1318 Actuator

1320 Shaft

1322 Adjuster

1324 Linkage

1326 Pivot

1328 Linkage

1330 Ratchet

1332 Pivot

1334 Jack

1336 Pneumatic or Hydraulic Element

1338 Pump

1340 Wedge Assembly

1342A, 1342B Wedge

1344 Actuator

1346 Shaft

1348 Worm Gear Assembly

1350 Worm Gear

1352 Worm Wheel

1354 Pivot

1356A, 1356B Jack

1358 Actuator

1360 Shaft

1362 Hinged Assembly

1364 Linkages

1366 Hinges

1368A, 1368B Plate

1370A, 1370B Apertures

1400 Flow Element

1402 Linkage

1404 Ratchet

1406 Pivot

1500 Flow Element

1502 Actuation Element

1504 Flow

1506 Opening or Port

1508 Hinge

1510 Float

1512 Linkage

1514 Hinge

1516 Hinge

1600 Schematic

1602 Schematic

1604 Actuation Element

1606 Flow

1608 Opening or Port

1610 Hinge

1612 Surface Height Difference across Controlled Flow Baffle

### DETAILED DESCRIPTION

Although the following text sets forth a detailed description of numerous different embodiments, it should be understood that the legal scope of the description is defined by the words of the claims set forth at the end of this disclosure. The Detailed Description is to be construed as exemplary only and does not describe every possible embodiment of the treatment tank with controlled flow baffles since describing every possible embodiment would be impractical, if not impossible. Numerous alternative embodiments could be implemented, using either current technology or technology developed after the filing date of this patent, which would still fall within the scope of the claims. Additionally, any combination of features shown in the various figures can be used to create additional embodiments of the present disclosure. Thus, dimensions, aspects, and features of one embodiment of the treatment tank with controlled flow baffles can be combined with dimensions, aspects, and features of another embodiment of the treatment tank with controlled flow baffles to create the claimed embodiment.

Embodiments of the present disclosure are directed to controlled flow baffles for a treatment tank. The treatment tank receives water or wastewater in need of treatment, and outputs treated water or wastewater. During treatment, the received water or wastewater is subjected to one or more stages of a water or wastewater treatment process within the treatment tank. The treatment tank includes zones defined by the controlled flow baffles, where the various stages of the water or wastewater treatment process are isolated to one or more defined zones. To maintain a desired (e.g., controlled) weir crest over the controlled flow baffles, the controlled flow baffles include actuation elements and/or flow elements that may be actuated to open and close openings within the controlled flow baffles and/or adjust a proximal end of the controlled flow battles to maintain a predetermined weir elevation of the weir crest. The actuation elements and/or flow elements are driven by a control mechanism, which may be passive in operation and/or which may be operated in response to manual controls and/or automatic controls from a control system.

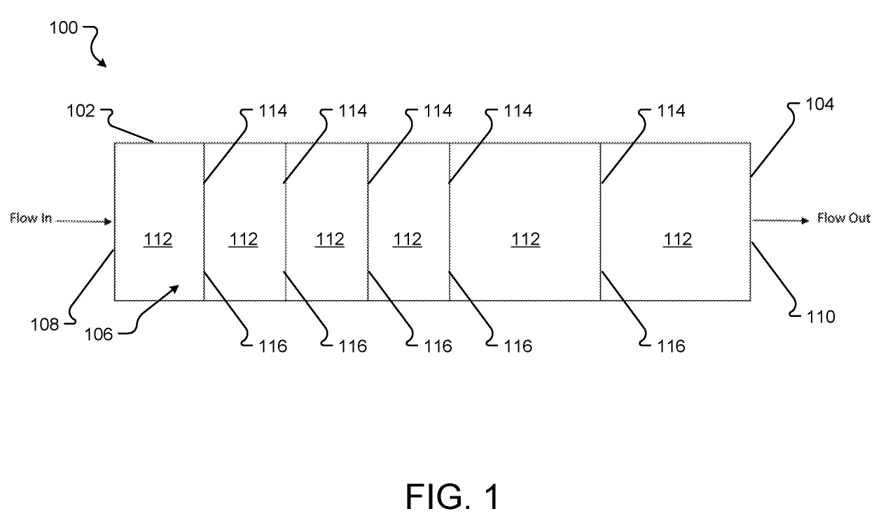

FIG. 1 illustrates a treatment system 100, in accordance with one or more embodiments of the present disclosure. It is noted that the treatment system 100 is provided only at a high level of generality, and that the configuration and/or design of the treatment system 100 as illustrated in FIG. 1 is not intended on being limiting to the present disclosure.

In embodiments, the treatment system 100 includes a treatment tank 102. The treatment tank 102 includes one or more boundaries or walls 104 that are arranged in any of a number of configurations. For example, the treatment tank 102 may have a rectangular cross-section in area, and include boundaries or walls 104 arranged to form a rectangular prism. By way of another example, the treatment tank 102 may have an oval or elliptical cross-section in area, and have boundaries or walls 104 arranged to form a volume defined by a rectangular prism inner portion capped by two hemi-spherical outer portions.

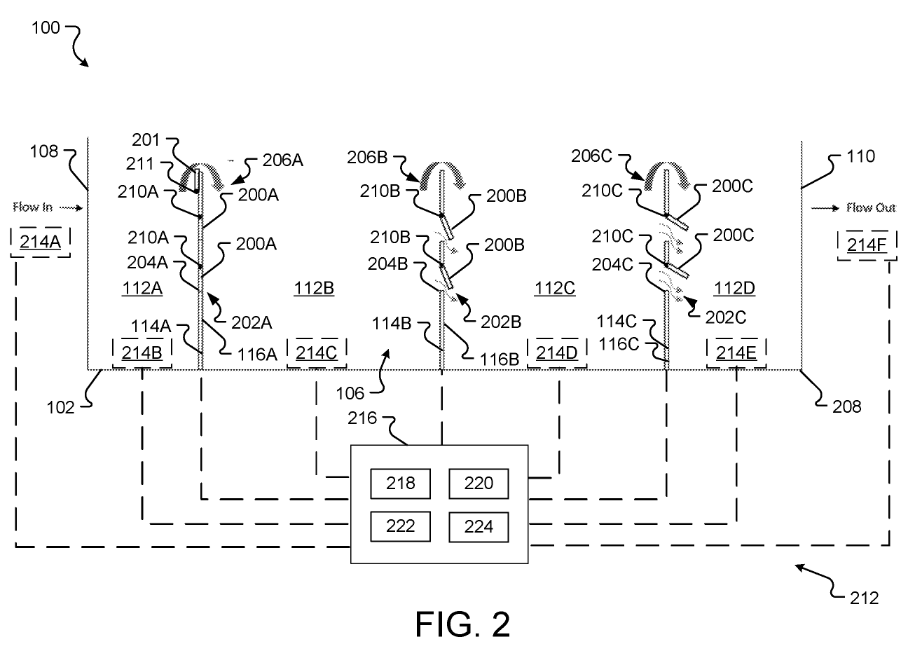

The treatment tank 102 may optionally include a bottom structure (e.g., bottom 208, as illustrated in FIG. 2) to enclose a cavity 106 defined within the treatment tank 102 in addition to the one or more boundaries or walls 104, without departing from the scope of the present disclosure. However, in at least some configurations the bottom of the treatment tank 102 may be open (e.g., such as when treated water is to be returned to an upstream physical location or treatment tank 102).

The treatment tank 102 may optionally include a top structure or lid to enclose the cavity 106 defined within the treatment tank 102 in addition to the one or more boundaries or walls 104, without departing from the scope of the present disclosure. However, in at least some configurations the top of the treatment tank 102 may be open (e.g., such as when the treatment tank 102 is open-air as with some select water or wastewater treatment facilities).

It should be understood that the one or more of the boundaries or walls 104, the optional bottom structure 208, and/or the optional top structure may be integrally formed as the treatment tank 102, or may be separately formed and joined together to form the treatment tank 102, without departing from the scope of the present disclosure.

In embodiments, water or wastewater flows into the treatment tank 102 through an inlet 108 in the treatment tank 102. The water or wastewater passes through one or more stages of a water or wastewater treatment process within the cavity 106 of the treatment tank 102, before flowing out of the treatment tank 102 through an outlet 110 in the treatment tank 102. For example, the inlet 108 may be in a first endwall of the treatment tank 102, and the outlet 110 may be in a second endwall of the treatment tank 102. By way of another example, the inlet 108 may be through a top structure or a top opening of the treatment tank 102, and the outlet 110 may be through a bottom structure or a bottom opening of the treatment tank 102. In general, the treatment tank 102 includes one or more inlets 108 for water or wastewater in need of treatment to enter the treatment tank 102 (e.g., either pre-treatment, or post-treatment and recycled for another pass through the treatment process), and one or more outlets 110 for post-treated water or wastewater to exit the treatment tank 102.

In embodiments, the cavity 106 defined within the treatment tank 102 is separated into a plurality of zones 112 by one or more controlled flow baffles 114. For example, one or more of each of the plurality of zones 112 may be specific to a particular stage (or stages) of the water or wastewater treatment process that occurs within the treatment system 100. As such, separating the zones (aside from transfer between the zones) by the one or more controlled flow baffles 114 is beneficial to increase isolation and/or process function of the stages of the water or wastewater treatment process.

The water or wastewater may flow over the top of the controlled flow baffles 114, forming a weir crest, as the water or wastewater passes through or across the zones 112 and each respective specific stage (or stages) of the water or wastewater treatment process. It is noted that in many wastewater applications, it is desirable to have a weir crest be controlled during passage through the treatment tank to facilitate improved zone treatment efficacy and surface flow characteristics.

However, due to changes in operational parameters within the treatment tank 102 (e.g., such as changes in head loss, velocity, pressure, and the like), the weir crest may have high and/or low points in various zones 112 within the treatment tank 102. To address inconsistency in weir crest elevation within the treatment tank 102, the controlled flow baffles 114 of the treatment tank 102 can include actuation elements to increase or decrease the size of openings within a surface 116 of the controlled flow baffles 114.

FIG. 2 and FIGS. 7A-16B generally illustrate the treatment system 100, the controlled flow baffles 114, and components of the same, in accordance with one or more embodiments of the present disclosure. It is noted that the treatment system 100 is provided only at a high level of generality, and that the configuration and/or design of the treatment system 100 as illustrated in FIG. 2 is not intended on being limiting to the present disclosure. In particular, it should be understood that FIGS. 1 and 2 both include the treatment tank 102, although the number of controlled flow baffles 114 may differ between the two figures, such that embodiments directed to the treatment tank 102 in FIG. 1 and the embodiments directed to the treatment tank 102 in FIG. 2 are interchangeable.

In embodiments, each controlled flow baffle 114 includes one or more actuation elements 200 arranged in one or more directions (e.g., in a depth direction and/or in a width direction across a surface 116 of the controlled flow baffle 114). For example, as illustrated in FIG. 2, the controlled flow baffles 114 include at least two actuation elements 200 with a first actuation element 200 at a shallower depth within the treatment tank 102 and a second actuation element 200 at a deeper depth within the treatment tank 102 (e.g., where depth may be defined relative to create elevation). By way of another example, although not shown, multiple actuation elements 200 may be in a particular row at a particular substantially similar depth within the treatment tank 102, without departing from the scope of the present disclosure. It is noted that the controlled flow baffles 114 in the treatment tank 102 in FIG. 2 are provided to illustrate various states of actuation element 200 and are not intended on being limiting for purposes of present disclosure, including with respect to baffle flow 202 and the arrangement and/or timing of opening and closing openings or ports 204 within the controlled flow baffles 114 by the actuation elements 200.

In general, the actuation elements 200 of the controlled flow baffles 114 may be configured to constantly and/or consistently control the crest elevation over respective controlled flow baffles 114 at any location within the treatment tank 102 between the inlet 108 for flow-in and the outlet 110 for flow-out.

In one exemplary configuration, the controlled flow baffle 114A includes actuation elements 200A in a closed position or a low flow position. With the actuation elements 200A in the closed position or the low flow position, flow 202A between zone 112A and zone 112B through openings or ports 204A within a surface 116A of the controlled flow baffle 114A is reduced or stopped entirely (e.g., down to approximately 0% flow rate). Instead, where there is flow past the controlled flow baffles 114A, the flow 202A past the controlled flow baffle 114A is generally restricted to cresting over the controlled flow baffle 114A as a weir crest 206A.

In another exemplary configuration, the controlled flow baffle 114B includes actuation elements 200B in a partially open position or a moderate flow position. With the actuation elements 200Bin the partially open position or the moderate flow position, flow 202B between zone 112B and zone 112C through openings or ports 204B within a surface 116B of the controlled flow baffle 114B is optionally a pre-determined amount that ranges between approximately 0% and approximately 100% flow rate. Flow past the controlled flow baffle 114Bmay also include a crest over the controlled flow baffle 114C as a weir crest 206B, including optionally in a pre-determined amount that ranges between approximately 0% and approximately 100% flow rate.

In a further exemplary configuration, the controlled flow baffle 114C includes actuation elements 200C in a fully open position or a high flow position. With the actuation elements 200Cin the fully open position or the high flow position, flow 202C between zone 112C and zone 112D through openings or ports 204C within a surface 116C of the controlled flow baffle 114C is increased or at a maximum rate (e.g., up to approximately 100% flow rate). Flow past the controlled flow baffle 114Amay also include a crest over the controlled flow baffle 114C as a weir crest 206C, although it is contemplated that the fully open position or high flow position may be sufficient to not require additional flow to crest over the controlled flow baffles 114C.

In general, it is contemplated in a non-limiting embodiment that the rate of flow 202Bthrough openings or ports 204B may be less than the rate of flow 202Cthrough openings or ports 204C, but that the weir crest 206B may be greater than the weir crest 206C, where the same rate of flow is applied to both the moderate flow configuration of the controlled flow baffle 114B and the high flow configuration of the controlled flow baffle 114C.

It is noted that the positioning of the actuation elements 200 and corresponding openings or ports 204 within the controlled flow baffles 114 in FIG. 2 is not intended on being limited to the present disclosure. For example, the actuation elements 200 and corresponding openings or ports 204 may be positioned in a lower portion of the controlled flow baffles 114. By way of another example, the actuation elements 200 and corresponding openings or ports 204 may be positioned in at approximately the midpoint along the height of the controlled flow baffles 114. Further, the actuation elements 200 and corresponding openings or ports 204 may be positioned in an upper portion of the controlled flow baffles 114.

In addition, it is noted that the controlled flow baffles are not limited to the actuation element 200. For example, one or more flow elements 201 of the controlled flow baffles 114 may be positioned proximate to (e.g., at or near) the top edge or surface of the controlled flow baffle 114, in addition to or instead of the actuation elements 200 within the surface 116 of the controlled flow baffles 114. In some instances, the flow element 201 may be actuatable and adjustable to increase or reduce the weir crest 206 for the particular controlled flow baffle 114 to be above, at, or below the elevation of the liquid surface. In other instances, the flow element 201 are static structures coupled to or integrally formed with a proximal end of the controlled flow baffle 114.

With the various positions of the actuation elements 200A, 200B, 200C and flow element 201 and resultant respective baffle flow 202A, 202B, 202C, the water or wastewater flowing through the treatment tank 102 between the inlet 108 and the outlet 110 may have a constant and/or consistent controlled elevation for weir crests over the respective controlled flow baffles 114A, 114B, 114C. For example, a weir crest 206Aover the controlled flow baffle 114A, a weir crest 206B over the controlled flow baffle 114B, and a weir crest 206C over the controlled flow baffle 114C may be maintained to controlled levels (or heights) due to adjustment of the additional respective baffle flow 202A, 202B, 202C through or over the respective openings or ports 204A, 204B, 204C within the respective controlled flow baffles 114A, 114B, 114C, depending on the positioning of the respective actuation elements 200A, 200B, 200C and flow element 201.

In embodiments, the actuation of the actuation elements 200A, 200B, 200C and flow element 201 is driven by respective control mechanisms 210A, 210B, 210C, 211. For example, the control mechanisms 210A, 210B, 210C, 211 may be manually-operated by a user monitoring operational parameters within the treatment tank 102, including via direct-drive mechanical assemblies and/or via electrical assemblies controlled by user inputs of a user or from a control system 212. By way of another example, the control mechanisms 210A, 210B, 210C, 211 may be automatically-operated by the control system 212 monitoring operational parameters within the treatment tank 102 (e.g., via sensors 214B, 214C, 214D, 214Eand/or with sensors 214A, 214F proximate to the inlet 108 and outlet 110 of the treatment tank 102). In further examples, a combination of manual and automated control mechanisms 210, 211 may be used.

In some non-limiting instances, such as where the actuation elements 200 and flow elements 201 is a plate or gate, the control mechanisms 210, 211 may include manually-driven actuators and/or servos or other motors or pneumatics that actuate the plate or gate via a translating motion (e.g., along tracks or rails) or a rotating motion (e.g., about an axis through a hinge). In other non-limiting instances, such as where the actuation elements 200 and flow elements 201 is a shutter (e.g., similar to a camera aperture, or a vent cover with multiple slats), the control mechanisms 210, 211 may include manually-driven actuators and/or servos or other motors or pneumatics that actuate the shutter via a translating motion (e.g., along tracks or rails for the aperture blades) or a rotating motion (e.g., about an axis through a central axis through the slats). It is noted that the servos or other motors or pneumatics may be considered components of the control system 212 and/or in communication with components of the control system 212 (e.g., such as control units 216).

In embodiments, the control system 212 includes one or more control units 216 (e.g., a controller, server, or the like). The one or more sensors 214 may be coupled (e.g., physically coupled, electrically coupled, communicatively coupled, or the like) to or integrated in the control system 212, the one or more control units 216, the treatment tank 102, and/or the subassemblies and/or components of the treatment tank 102. The one or more sensors 214 may be operable to determine various operational, physical, and/or environmental parameters of the treatment tank 102, the subassemblies and/or components of the treatment tank 102, and/or the control system 212; the environment surrounding the treatment tank 102, the subassemblies and/or components of the treatment tank 102, and/or the control system 212; and the like. In one non-limiting example, the sensors 214 may be operable to determine the surface elevation of the water or wastewater within the cavity 106 of the treatment tank 102, and/or the zones 112 defined within the cavity 106 by the controlled flow baffles 114.

The one or more control units 216 may include processors 218 and memory 220 (e.g., a memory medium, memory device, or the like). The processors 218 may be configured to execute program instructions maintained on or stored in the memory 220. The processors 218 of the one or more control units 216 may execute any of the various method or process steps necessary to operate the control mechanisms 210, 211 and/or the sensors 214 within the treatment system 100, and/or the subassemblies and/or components of the treatment system 100 including the actuation elements 200.

The control system 212 may include a user interface 222. For example, the user interface 222 may be a separate device coupled (e.g., physically coupled, electrically coupled, communicatively coupled, or the like) to the one or more control units 216. By way of another example, the user interface 222 and the one or more control units 216 may be located within a common or shared housing. The user interface 222 may include one or more displays, one or more user input devices, and/or one or more port connectors (e.g., for the transmitting and/or receiving of power and/or data, and the like). For example, the one or more user input devices may include components to manually and/or electrically control the control mechanisms 210, 211 to adjust the position of the actuation elements 200.

The control system 212 may include one or more transmitters and/or receivers 224 coupled (e.g., physically coupled, electrically coupled, communicatively coupled, or the like) to or integrated in the one or more control units 216, the treatment tank 102, and/or the subassemblies and/or components of the treatment tank 102. The one or more transmitters and/or receivers 224 may be configured to transmit data and/or receive data for the treatment tank 102 and/or the subassemblies and/or components of the treatment tank 102 (e.g., from sensors 214 installed within or associated with the treatment tank 102 and/or the subassemblies and/or components of the treatment tank 102) or from external third-party control units (e.g., controllers, servers, or the like) either via wired connections or wireless connections, which may be configured as transmitting (Tx) units, receiving (Rx) units, or combination Tx/Rx units.

The control system 212 may be configured to monitor the treatment tank 102 and/or the subassemblies and/or components of the treatment tank 102 via received and/or transmitted data. The control system 212 may be configured to generate control signals to adjust one or more components of the treatment tank 102 and/or the subassemblies and/or components of the treatment tank 102 via a feedback loop or a feed forward loop based on the received and/or transmitted data, either automatically or following an input from a user. The control system 212 may be configured to receive and/or transmit data in a standardized format and/or a non-standardized format. Where the data is in a non-standardized format, the data may be converted to a standardized format upon receipt and/or prior to transmission to sensors, third-party control units, or the like.

It should be understood that the treatment system 100 may include non-transitory computer-readable medium having stored thereon instructions that, when read by at least one microprocessor, cause the at least one microprocessor to perform the operations as substantially described herein. In this regard, at least a portion of the disclosure may be understood as being directed to a computer-implemented method, as at least a portion of the disclosure may be understood as being directed to a computer-implemented invention.

Although embodiments of the present disclosure are directed to automatic and/or manual means of operation of the actuation elements 200 and flow elements 201 by the respective control mechanisms 210, 211, it should be understood that the present disclosure is not limited to these active means of control. Alternatively or in addition, embodiments of the present disclosure are directed to passive means of control of the actuation elements 200 and flow elements 201, including by forces associated with flow-induced head loss, buoyancy forces, or other means not requiring actuation by operator or controller.

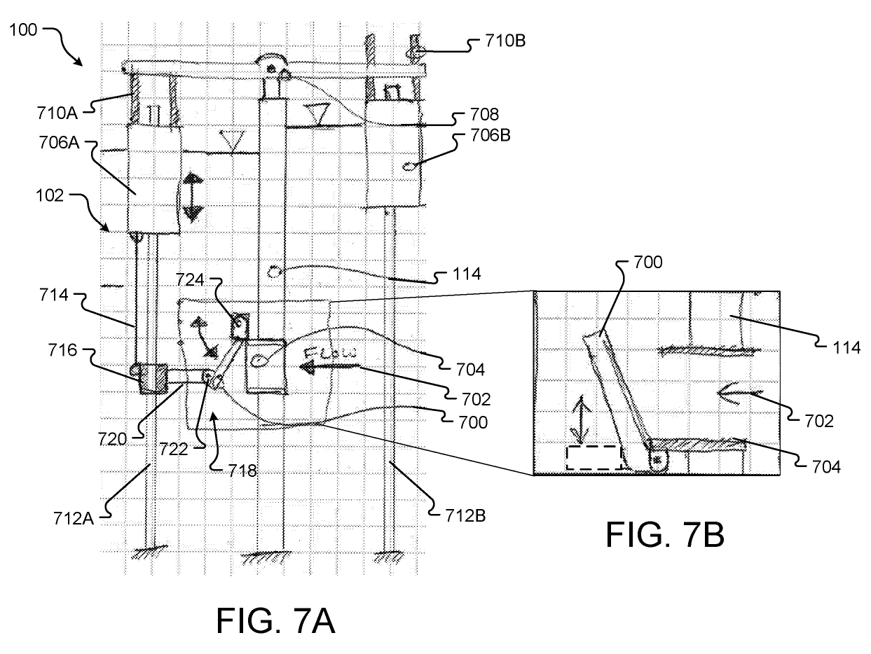

FIGS. 7A-16B generally illustrate non-limiting examples of the actuation elements 200 and flow elements 201 which are provided in accordance with one or more embodiments of the present disclosure. In some configurations, the various actuation elements 200 and flow elements 201 illustrated in FIGS. 7A-16B may be passive in operation or may be fixed in place. However, it is contemplated that any of the passively operated elements 200, 201 may be configured to be actively controlled via automatic or manual means, without departing from the scope of the present disclosure.

Referring now to FIGS. 7A and 7B, a variation of the actuation element 200, labelled actuation element 700, is shown with a controlled flow baffle 114. The actuation element 700 is operable as an adjustable flow flap gate, where flow 702 through an opening 704 within the controlled flow baffle 114 is passively controlled by the opening and closing of the actuation element 700. It should be understood that the actuation element 700 may be installable and usable with any treatment system and/or installable on the controlled flow baffle as described throughout the present disclosure, both as standalone actuation elements or in combination with other variations of the actuation element 200 within the treatment system and/or installable on the controlled flow baffle.

In embodiments, at least one float 706 is installed within the treatment tank 102 of the treatment system 100. For example, a float 706A may be installed downstream or downflow of the controlled flow baffle 114. By way of another example, a float 706B may be installed upstream or upflow of the controlled flow baffle 114. In general, the floats 706A, 706Bmay be fabricated from a material that is buoyant within a liquid within the treatment tank 102, and is able to float at or proximate to a surface of the liquid.

In embodiments, the floats 706A, 706B may be in communication with a pivot arm 708, where the pivot arm 708 pivots relative to the controlled flow baffle 114. In some configurations, the pivot arm 708 may be coupled to an uppermost point and/or an extension projected above the controlled flow baffle 114, above the weir crest (and optionally above the liquid surface level. In other configurations, the pivot arm 708 may be inserted into and pivotable with respect to an aperture within the controlled flow baffle 114, including optionally below the liquid surface level.

Optionally, the floats 706A, 708B may be connected to the pivot arm 708 via respective adjustable connectors 710A, 710B including, but not limited to, threaded rods or other interlocking assemblies. It is contemplated that the connectors 710A, 710B being adjustable allows for the setting of the initial depth for the respective float 706A, 706B relative to the pivot arm 708, including to calibrate the initial open and/or closed position for the actuation element 700 and/or the initial rate of flow 702 through the opening 704 (and/or over the controlled flow baffles 114, as a weir crest). For instance, where both floats 706A, 706B are used, the respective initial height of the floats 706A, 706B may be different.

In one non-limiting example, liquid surface height downstream of the actuation element 700 may dictate the height of the float 706A, and/or liquid surface height upstream of the actuation element 700 may dictate the height of the float 706B. Where both the floats 706A, 706B are in use and coupled to the same pivot arm 708, one of the floats 706A, 706B may override and dictate the height of the other of the floats 706A, 706B. With the adjustment of the float 706A, 706B, the actuation element 700 may open or close to adjust flow 702 and maintain pressure differential across the controlled flow baffle 114.

In embodiments, the float 706A and/or the float 706B may be able to float within the treatment tank 102 relative to a respective stand 712A, 712B. For example, the stand 712A, 712B may be fixed in position within the treatment tank 102, and the respective float 706A, 706B may translate to a shallower or deeper depth within the treatment tank 102 relative to the stand 712A, 712B and in response to a change in liquid surface height. In one non-limiting configuration, the float 706A, 706B includes an aperture able to receive the respective stand 712A, 712B, though it is contemplated that the float 706A, 706B may be couplable to the respective stand 712A, 712B via other connections without departing from the scope of the present disclosure.

In embodiments, the float 706A is coupled to the actuation element 700 (though it is contemplated the float 706B may be coupled to the actuation element 700, without departing from the scope of the present disclosure). For example, a linkage 714 may couple a collar 716 located about the stand 712A to the float 706A. Where the linkage 714 is of a fixed, non-adjustable length and the collar 716 is able to translate relative to the stand 712A, movement of the float 706A relative to the stand 712A with a change in the liquid surface height is transferred through the linkage 714 to the collar 716, which similarly translates relative to the stand 712A.

The collar 716 is in communication with a linkage assembly 718, including a linkage 720 that couples to the actuation element 700 via a bracket 722 or other connector. The actuation element 700 is coupled to a pivot 724 on or proximate to the controlled flow baffle 114. Translation of the collar 716 is transferred to the actuation element 700 via the linkage assembly 718, causing the actuation element 700 to rotate about an axis through the pivot 724 and open or close depending on the translation of the collar 716. In one instance, where the liquid surface height raises or increases, causing the float 706A to raise which is translated to the collar 716 raising, the linkage assembly 718 is configured to cause the actuation element 700 to rotate about the axis through the pivot 724 to close the actuation element 700 and reduce flow 702 through the opening 704.

It should be understood that the described configuration of the linkage assembly 718 is non-limiting, and that other configurations of the linkage assembly 718 are contemplated without departing from the scope of the present disclosure. In addition, although embodiments are directed to the linkage assembly 718 being separate from the collar 716, it should be understood that the collar 716 and/or the linkage 714 may be considered components of a linkage assembly 718 that generally connects the float 706A and the actuation element 700, without departing from the scope of the present disclosure.

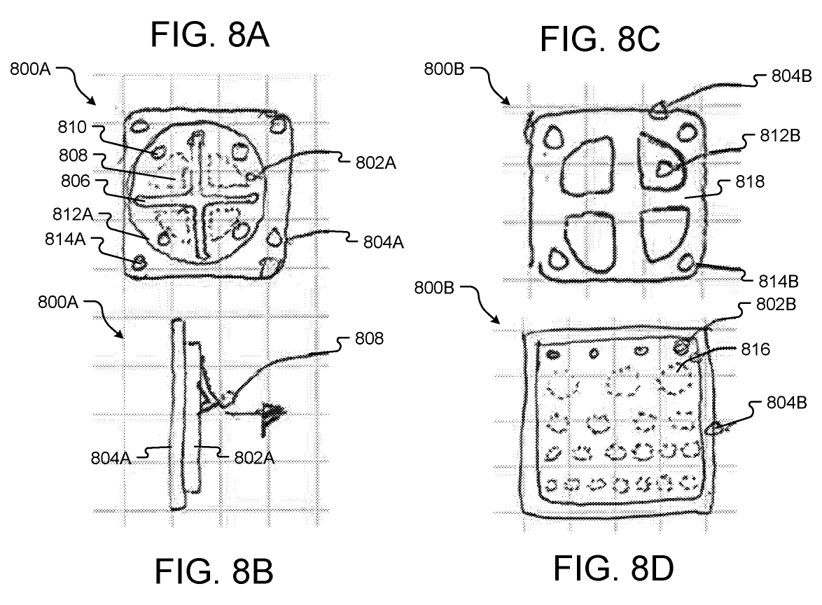

Referring now to FIGS. 8A-8D, variations of the actuation element 200, labelled actuation element 800A, 800B are shown. The actuation element 800A, 800B is operable as a “heart valve” flap valve, where flow through an opening within the controlled flow baffle is passively controlled by the opening and closing of the portions of the actuation element 800A, 800B. It should be understood that the actuation element 800A, 800B may be installable and usable with any treatment system and/or installable on the controlled flow baffle as described throughout the present disclosure, both as standalone actuation elements or in combination with other variations of the actuation element 200 within the treatment system and/or installable on the controlled flow baffle.

In one non-limiting example as illustrated in FIGS. 8A and 8B, the actuation element 800A includes a flapper 802A and a backing plate 804B to which the flapper 802A is coupled. The flapper 802A includes slots 806 that form flaps 808, where the flaps 808 move in response to forces from the fluid in the treatment tank or treatment system. For example, with increased flow the flaps 808 may adjust to a more open position, while with decreased flow the flaps 808 may adjust to a more closed position. Optionally, the flaps 808 may include additional apertures 810 to assist in pliability and/or flow.

The backing plate 804A may include one or more cutouts 812A for flow to/from the flapper 802A. Optionally, the backing plate 804A may include one or more apertures 814A for mounting the flapper 802A to the backing plate 804A and/or mounting the actuation element 800A to the controlled flow baffle proximate to an opening. In general, however, it is contemplated that the actuation element 800A may be mounted to the controlled flow baffle using any of a number of coupling techniques, including fasteners, interlocking assemblies, press-fit or interference fit, adhesives, and the like.

In another non-limiting example as illustrated in FIGS. 8C and 8D, the actuation element 800B includes a flapper 802B and a backing plate 804B to which the flapper 802B is coupled. The flapper 802B includes a plurality of apertures 816. For example, the plurality of apertures 812 may be constant in size, or alternatively may differ in size (e.g., either between different actuation elements 800B or on the same flapper 802B of a particular actuation element 800B). For instance, the differing in aperture 812 size may accommodate different flow rates.

The backing plate 804A may include one or more cutouts 812B for flow to/from the flapper 802B. Where there are multiple cutouts 812B, the cutouts 812B may be separated by dividers 818 (as similarly contemplated for cutouts 812A of actuation element 800A). Optionally, the backing plate 804B may include one or more apertures 814B for mounting the actuation element 800B to the controlled flow baffle proximate to an opening. In general, however, it is contemplated that the actuation element 800B may be mounted to the controlled flow baffle using any of a number of coupling techniques, including fasteners, interlocking assemblies, press-fit or interference fit, adhesives, and the like.

In at least some embodiments, the flapper 802A is formed of a flexible and/or resilient material. The material is selected to be one or more of flexible and bendable in response to forces received from the fluid. Suitable materials that may be used to form the flapper are known to those of skill in the art. In general, the flappers 802A, 802B may be fabricated from a rubber or other pliable and non-reactive material, including optionally being die cut. In addition, the backing plates 804A, 804B may be fabricated from a metal or other rigid material, including but not limited to a stainless steel or other non-reactive material.

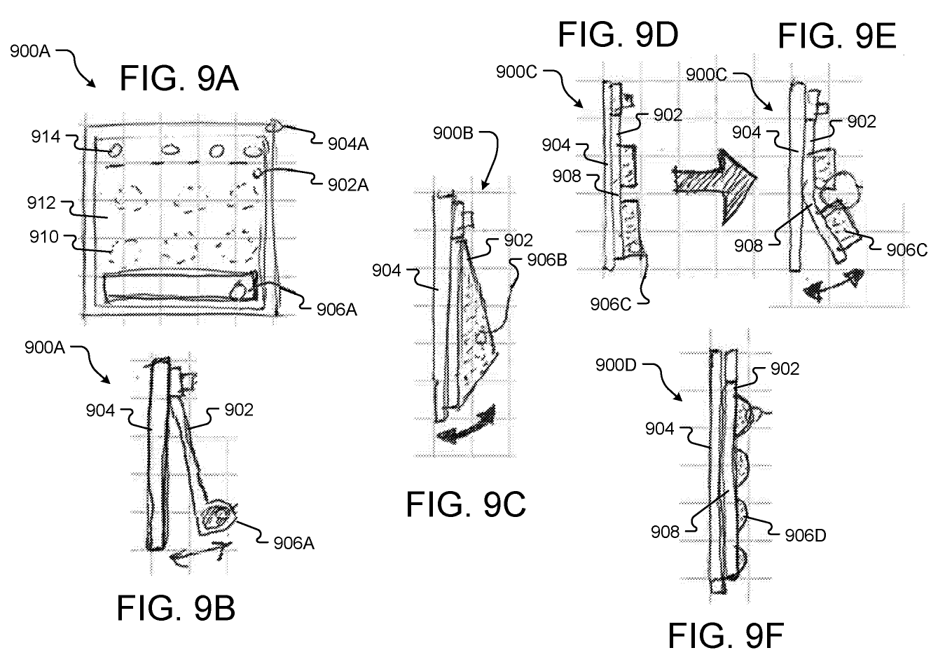

Referring now to FIGS. 9A-9F, a variation of the actuation element 200, labelled actuation element 900A, 900B, 900C, 900D, is shown. The actuation element 900A, 900B, 900C, 900D is operable as a buoyant flow flap, where flow through an opening within the controlled flow baffle is passively controlled by the opening and closing of the actuation element 900A, 900B, 900C, 900D. It should be understood that the actuation element 900A, 900B, 900C, 900D may be installable and usable with any treatment system and/or installable on the controlled flow baffle as described throughout the present disclosure, both as standalone actuation elements or in combination with other variations of the actuation element 200 within the treatment system and/or installable on the controlled flow baffle.

In one non-limiting example as illustrated in FIGS. 9A and 9B, the actuation element 900A includes a flapper 902 and a backing plate 904 to which the flapper 902 is coupled. The flapper 902 includes a buoyant core 906A. For example, the buoyant core 906A may assist in opening or closing the flapper 902 when pressure differential changes across the controlled flow baffle.

As illustrated in FIGS. 9A and 9B, the buoyant core 906A may be localized to a particular region (e.g., near a distal end located deeper within the treatment tank) on the flapper 902. However, as illustrated in FIG. 9C, the buoyant core 906B may be coupled to a substantial portion of the flapper 902, with a cross-section that is selected based on a pre-determined pressure differential to assist in opening or closing the flapper 902.

FIGS. 9D and 9E illustrate a set of buoyant cores 906C of an actuation element 900C that are separated on the flapper 902 by a crease region 908 of the flapper 902. Installing separate buoyant cores 906C on the flapper 902 to be separated by the crease region 908 may allow for more free articulation of the flapper 902 depending on pressure differential across the controlled flow baffle.

In embodiments, the flapper 902 may comprise a flexible material. In this manner, in a first configuration, the flapper 902 may be general planar as illustrated in FIG. 9D. However, in response to a change in condition (e.g., such as a level of fluid in the treatment tank or treatment system or a zone, or a force of fluid against the flapper 902), the flapper may bend at the crease region 908 and transition to a second configuration as generally illustrated in FIG. 9E to alter a size of passage through the opening or port formed by the actuation element 900C.

As illustrated in FIGS. 9D and 9E, the buoyant cores 906C may substantially similar in cross-section and/or volume. However, as illustrated in FIG. 9F, buoyant cores 906D of an actuation element 900D may differ in cross-section and/or volume, which is/are selected based on a pre-determined pressure differential to assist in opening or closing the flapper 902.

Generally, the buoyant cores may be fabricated from a foam or other buoyant material able to be coupled to (e.g., via fasteners, interlocking assemblies, adhesives, or the like) to the flapper 902. The material used for form the buoyant core may optionally be closed-cell, or define a cavity able to contain air. The buoyant core 906 may have any cross-section. Where there are multiple buoyant cores installed on the flapper 902, the buoyant cores may have the same or different dimensions, and/or may be fabricated from the same or different material, to fine-tune the opening and closing of the actuation element 900 based on pressure differential across the controlled flow baffle. In one non-limiting example, the varying in cross-section and/or volume of the buoyant cores may be arranged to allow the flapper 902 to open more as pressure differential increases, to compensate for more force being required to open the flapper 902 further.

In embodiments, the backing plate 904 may include one or more cutouts 910 for flow to make contact with the flapper 902. For example, the one or more cutouts 910 may control a force applied to the flapper 902 by the flow of fluid through the backing plate 904. Where there are multiple cutouts 910, the cutouts 910 may be separated by dividers 912. Optionally, the backing plate 904 may include one or more apertures 914 for mounting the actuation element 900A, 900B, 900C, 900D to the controlled flow baffle proximate to an opening. In general, however, it is contemplated that the actuation element 900A, 900B, 900C, 900D may be mounted to the controlled flow baffle using any of a number of coupling techniques, including fasteners, interlocking assemblies, press-fit or interference fit, adhesives, and the like. The backing plate 904 may be fabricated from a metal or other rigid material, including but not limited to a stainless steel or other non-reactive material.

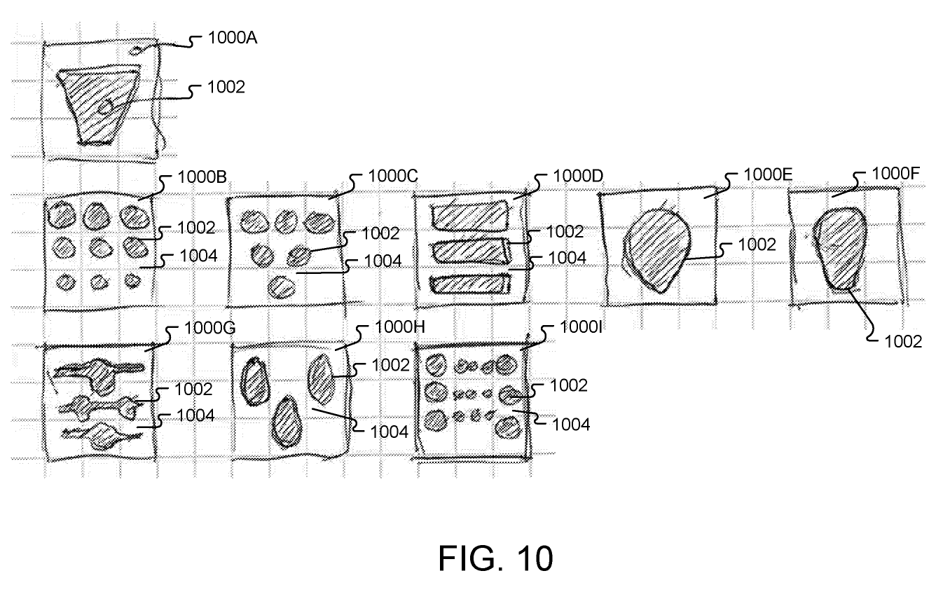

Referring now to FIG. 10, variations of the backing plates 804A, 804B illustrated in FIGS. 8A-8D and/or the backing plate 904 illustrated in FIGS. 9A-9F, labelled backing plate 1000A-1000I, are shown. The backing plate 1000A-1000I includes one or more cutouts 1002 that allow flow through the backing plate 1000A-1000I to a flapper (e.g., flapper 802A, 802B, 902).

The cutouts 1002 may have a constant shape or a varied shape to fine-tune the opening and closing of the flapper based on pressure differential across the controlled flow baffle. For example, the cutout 1002 may increase with width across the backing plate 1000A-1000I from the distal end (located at a deeper depth within the treatment tank) to a proximal end (located at a shallower depth within the treatment tank) to adjust force and flow as the flapper opens further relative to the distal end of the backing plate 1000A-1000I.

Where there are multiple cutouts 1002, the cutouts 1002 may be separated by dividers 1004. In addition, where there are multiple cutouts 1002, the cutouts 1002 may have the same or different shapes and/or dimensions to fine-tune the opening and closing of the flapper based on pressure differential across the controlled flow baffle.

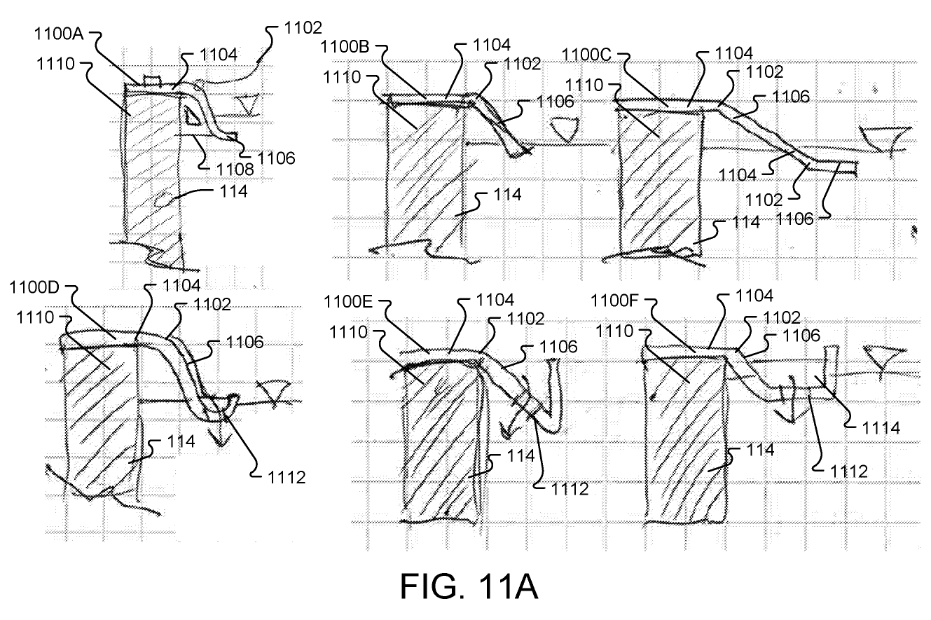

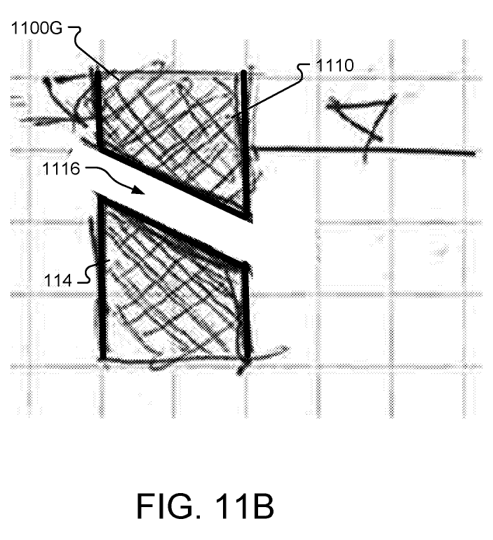

Referring now to FIGS. 11A and 11B, variations of the flow element 201, labelled flow element 1100A-1100G, are shown with a controlled flow baffle 114. The flow element 1100A-1100G is operable as a static flow element that passively provides a weir crest over the controlled flow baffle 114 with a smoother transition (e.g., to provide a less-turbulent flow over the controlled flow baffle 114). It should be understood that the flow element 1100A-1100G may be installable and usable with any treatment system and/or installable on the controlled flow baffle 114 as described throughout the present disclosure, both as standalone flow elements or in combination with other variations of the flow element 201 within the treatment system and/or on the controlled flow baffle 114.

In embodiments, as illustrated in FIG. 11A, the flow elements 1100A-1100F may have any cross-section that is contoured to conform to a particular line including one or more transitions 1102, where surrounding the transitions 1102 may be respective pre-transition portions 1104 and/or post-transition portions 1106 that are set at any angle relative to one another. For example, the general contouring of the cross-section of the flow elements 1100A-1100F may be selected based on a pre-determined smoothness of transition for the weir crest. The transition 1102 may be straight (e.g., with an angle of substantially zero) or may include, but is not limited to, bends or curves that conform to a particular radius of curvature, corners or steps that come to a point, or the like.

In some configurations, the flow elements 1100A-1100F may optionally include a brace 1108 that generally supports the flow elements 1100A-1100F on the post-weir crest side of the controlled flow baffle 114. For example, the brace 1108 may increase rigidity of the flow elements 1100A-1100F, including optionally making contact with a portion of the controlled flow baffle 114 at a proximal end 1110 of the controlled flow baffle 114.

In some configurations, the flow elements 1100A-1100F may optionally include one or more openings 1112 that allow for weir crest flow to pass into the region of the treatment tank beyond the controlled flow baffle 114 prior to clearing the flow elements 1100A-1100F. The openings 1112 may have a constant shape or a varied shape to fine-tune the transition of the weir crest over the controlled flow baffle 114.

In some configurations, the transitions 1102 and/or transition portions 1104, 1106 of the flow elements 1100A-1100F may optionally define a basin 1114 or other space that collects weir crest flow prior to entry into the region of the treatment tank beyond the controlled flow baffle 114. The basin 1114 may have a constant shape or a varied shape to fine-tune the transition of the weir crest over the controlled flow baffle 114. Optionally, the openings 1112 may provide a transition for weir crest flow between the basin 1114 and the region of the treatment tank beyond the controlled flow baffle 114.

In general, the flow elements 1100A-1100F may be fabricated from a metal or other rigid material, including but not limited to a stainless steel or other non-reactive material, although it is contemplated that the flow elements 1100A-1100F may be fabricated from a flexible material that adjusts in response to changes in weir crest flow. The flow elements 1100A-1100F may be couplable to the proximal end 1110 of the controlled flow baffle 114 via fasteners, interlocking assemblies, adhesives, or the like.

In one particular configuration as illustrated in FIG. 11B, flow element 1100G may not be an element coupled to the controlled flow baffle 114 but instead may be a channel 1116 through the controlled flow baffle 114 proximate to the proximal end 1110 of the controlled flow baffle 114 (and above any actuation elements 200 that may be installed on or in the controlled flow baffle 114). The channel 1116 includes a transition with pre- and post-transition portions that are set at any angle relative to one another. The transition of the channel 1116 may be straight (e.g., with an angle of substantially zero) or may include, but is not limited to, bends or curves that conform to a particular radius of curvature, corners or steps that come to a point, or the like.

The channel 1116 may have any cross-section through the opposite sides of the controlled flow baffle 114. The direction of the channel 1116 may be sloped or angled to fine-tune the transition of the weir crest over the controlled flow baffle 114, including optionally from a higher or shallower depth on the pre-weir crest side of the controlled flow baffle 114 to a lower or deeper depth on the post-weir crest side of the controlled flow baffle 114.

Optionally, the proximal end 1110 of the controlled flow baffle 114 may include one or multiple channels 1116, with the multiple channels 1116 being the same or different in length, contouring, cross-section, and the like.

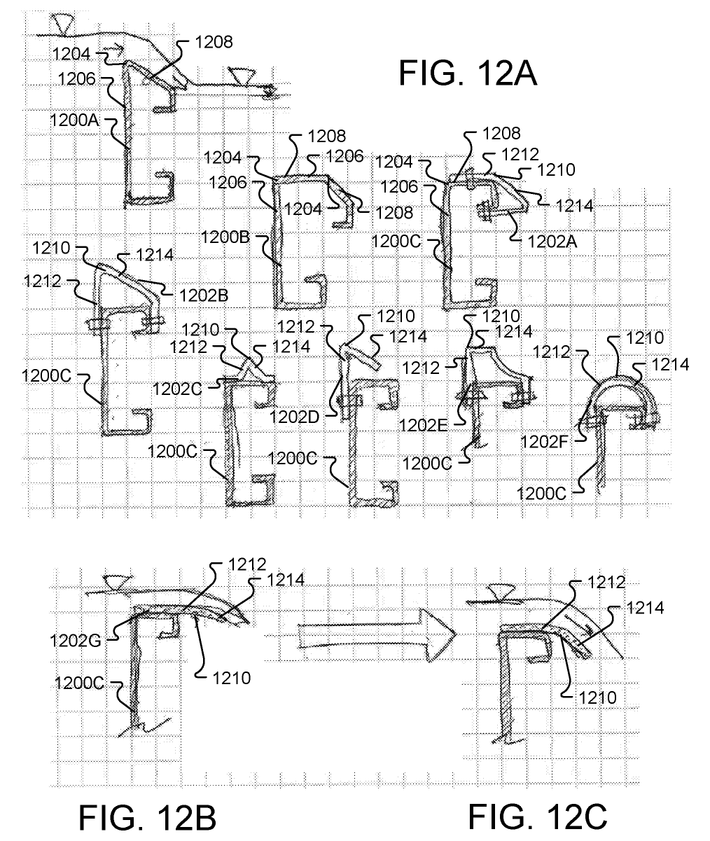

Referring now to FIGS. 12A-12C, variations of the proximal end 1110 of the controlled flow baffle 114 of FIGS. 11A and 11B, labelled ends 1200A-1200C, is shown. The ends 1200A-1200C are operable as a static flow element that passively provides a weir crest over the controlled flow baffle 114 with a smoother transition. Optionally, the ends 1200A-1200C, and in particular end 1200C, may be combinable with the flow elements 1100A-1100G and/or with variations of the flow element 201, labelled flow element 1202A-1202G in FIGS. 12A-12C. It should be understood that the ends 1200A-1200C, including optional flow elements 1100A-1100G, 1202A-1202G may be installable and usable with any treatment system and/or installable on the controlled flow baffle 114 as described throughout the present disclosure, both as standalone flow elements or in combination with other variations of the flow element 201 within the treatment system and/or on the controlled flow baffle 114.

In general, the proximal end 1200A-1200C may have any cross-section that is contoured to conform to a particular line including one or more transitions 1204, where surrounding the transitions 1204 may be respective pre-transition portions 1206 and/or post-transition portions 1208 that are set at any angle relative to one another. For example, the general contouring of the cross-section of the proximal end 1200A-1200C may be selected based on a pre-determined smoothness of transition for the weir crest. The transition 1204 may be straight (e.g., with an angle of substantially zero) or may comprise, but is not limited to, bends or curves that conform to a particular radius of curvature, corners or steps that come to a point, or the like.

The transition 1204 may be sloped or angled to fine-tune the transition of the weir crest over the controlled flow baffle 114, including optionally from a higher or shallower depth on the pre-weir crest side of the controlled flow baffle 114 to a lower or deeper depth on the post-weir crest side of the controlled flow baffle 114. In some configurations, the post-transition portion 1208 may be below the liquid surface height of the post-controlled flow baffle 114 region of the treatment tank.

Where the proximal end 1200A-1200C includes the flow element 1202A-1202G, the flow element 1202A-1202G may have any cross-section that is contoured to conform to a particular line including one or more transitions 1210, where surrounding the transitions 1210 may be respective pre-transition portions 1212 and/or post-transition portions 1214 that are set at any angle relative to one another. For example, the general contouring of the cross-section of the flow element 1202A-1202G may be selected based on a pre-determined smoothness of transition for the weir crest. The transition 1210 may be straight (e.g., with an angle of substantially zero) or may comprise, but is not limited to, bends or curves that conform to a particular radius of curvature, corners or steps that come to a point, or the like.

The transition 1210 may be sloped or angled to fine-tune the transition of the weir crest over the controlled flow baffle 114, including optionally from a higher or shallower depth on the pre-weir crest side of the controlled flow baffle 114 to a lower or deeper depth on the post-weir crest side of the controlled flow baffle 114. In some configurations, the post-transition portion 1214 may be below the liquid surface height of the post-controlled flow baffle 114 region of the treatment tank.

In general, the flow elements 1202A-1202G may be fabricated from a metal or other rigid material, including but not limited to a stainless steel or other non-reactive material, although at least FIGS. 12B and 12C illustrate the flow element 1202G as fabricated from a flexible material that adjusts in response to changes in weir crest flow, with a variable transition 1210 that has an adjustable angle between the pre-transition region 1212 and the post-transition region 1214 of the flow element 1202G. The flow elements 1202A-1202G may be couplable to the proximal end of the controlled flow baffle 114 (e.g., proximal end 1202C) via fasteners, interlocking assemblies, adhesives, or the like.

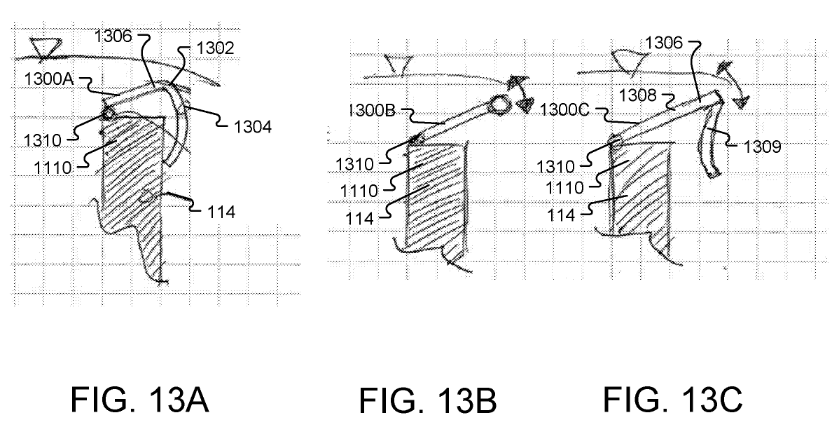

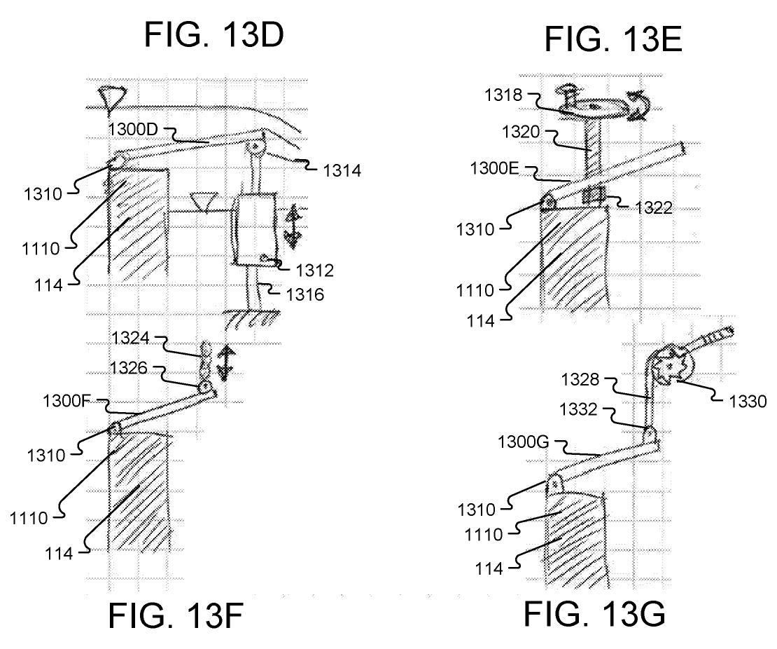

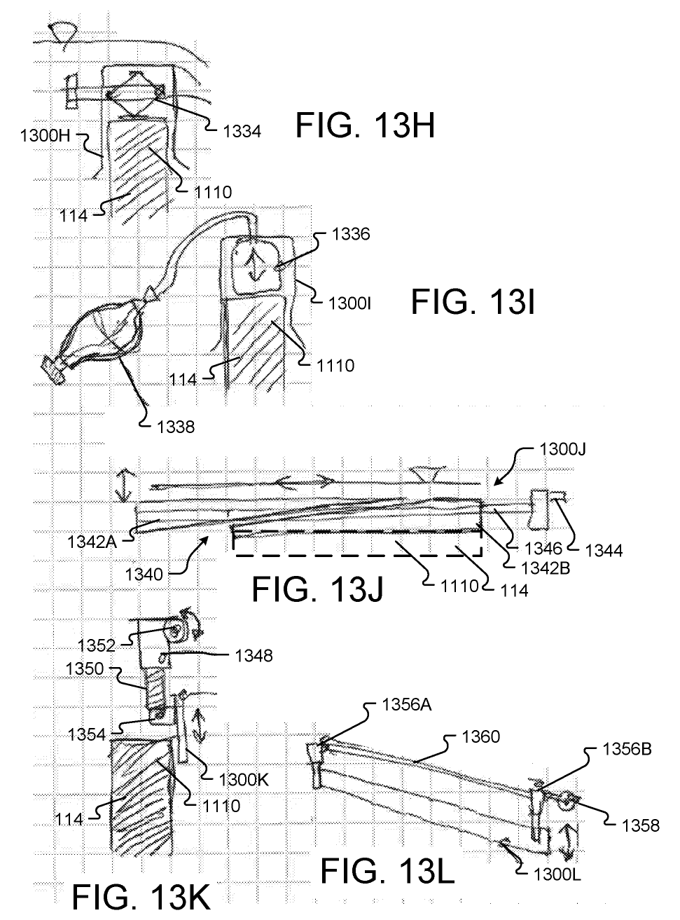

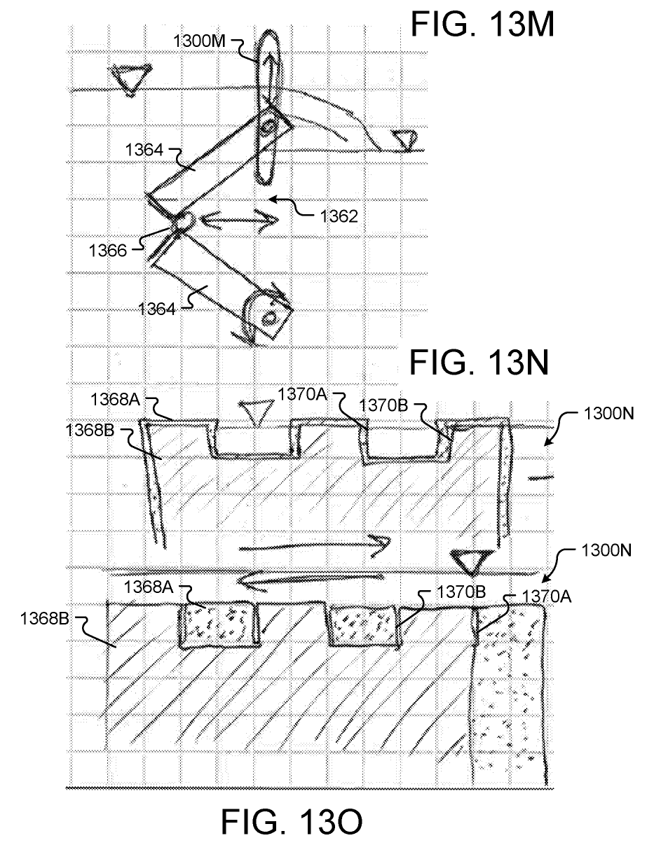

Referring now to FIGS. 13A-13O, variations of the flow element 201, labelled flow element 1300A-1300N, are shown with a controlled flow baffle 114. The flow element 1300A-1300N is operable as an adjustable flow element that provides a weir crest over the controlled flow baffle 114 with a smoother transition (e.g., to provide a less-turbulent flow over the controlled flow baffle 114). It should be understood that the flow element 1300A-1300N may be installable and usable with any treatment system and/or installable on the controlled flow baffle 114 as described throughout the present disclosure, both as standalone flow elements or in combination with other variations of the flow element 201 within the treatment system and/or on the controlled flow baffle 114.

In embodiments, the flow element 1300A-1300N may have any cross-section that is contoured to conform to a particular line including one or more transitions 1302, where surrounding the transitions 1302 may be respective pre-transition portions 1304 and/or post-transition portions 1306 that are set at any angle relative to one another. For example, the general contouring of the cross-section of the flow elements 1300A-1300N may be selected based on a pre-determined smoothness of transition for the weir crest. The transition 1302 may be straight (e.g., with an angle of substantially zero) or may include, but is not limited to, bends or curves that conform to a particular radius of curvature, corners or steps that come to a point, or the like.

In one particular configuration, as illustrated in FIG. 13C with the flow element 1300C, the flow element 1300C includes a primary section 1308 and at least one secondary section 1309. For example, the at least one secondary section 1309 may be angled with respect to the primary section 1308. By way of another example, the at least one secondary section 1309 may be hinged to the primary section 1308. The hinged secondary section 1309 may assist in directing weir crest flow, including optionally with the angle between the primary section 1308 and the secondary section 1309 changing as the primary section 1308 is adjusted. It is noted that the hinge may be considered a transition between the primary section 1308 and the secondary section 1309, for purposes of the present disclosure.

In embodiments, the flow element 1300A-1300N is coupled to the proximal end 1110 of the controlled flow baffle 114 via a hinge 1310. The flow element 1300A-1300N is adjustable using one or more passive, manual, or automatic means of control of one or more embodiments or aspects described herein.

For example, as illustrated in FIG. 13D, the flow element 1300D is coupled to a float 1312 that raises and lowers with the liquid surface height. Optionally, the flow element 1300D is coupled to the float 1312 via a hinge 1314 and/or the float 1312 raises or lowers relative to a stand 1316 that is fixed within the treatment tank, to maintain a particular configuration of the float 1312 within the treatment tank. It is noted that embodiments directed to the actuation of the float 706A, 706B may similarly be applicable to the float 1312, for purposes of the present disclosure.

By way of another example, as illustrated in FIG. 13E, the flow element 1300E is coupled to an actuator 1318 via a shaft 1320, which is coupled to an adjuster 1322. For instance, the shaft 1320 may be a threaded shaft and the adjuster 1322 is a nut that makes contact with the flow element 1300E, where rotation of the actuator 1318 (e.g., a wheel or lever) increases or decreases the engagement of complementary threading between the shaft 1320 and the adjuster 1322 to raise or lower the flow element 1300E. It is contemplated however that the shaft 1320 may act directly on the flow element 1300E, such that the adjuster 1322 is not required, without departing from the scope of the present disclosure.

By way of another example, as illustrated in FIG. 13F, the flow element 1300F is coupled to a rigid or substantially rigid linkage 1324 (e.g., including via an optional hinge or pivot 1326). For instance, raising or lowering the linkage 1324 is translated to raising or lowering the flow element 1300F. The linkage 1324 may include, but is not limited to, a chain or a cable.

By way of another example, as illustrated in FIG. 13G, the flow element 1300G is coupled to a flexible linkage 1328 of a ratchet 1330 (e.g., including via an optional hinge or pivot 1332). For instance, raising or lowering the linkage 1328 via the ratchet 1330 is translated to raising or lowering the flow element 1300G. The linkage 1324 may include, but is not limited to, a chain (i.e., being flexible at the joints connecting adjacent links), a strap or a cable.

By way of another example, as illustrated in FIG. 13H, the flow element 1300H is installed over the proximal end 1110 of the controlled flow baffle 114, and a jack 1334 is located between the proximal end 1110 of the controlled flow baffle 114 and the flow element 1300H. For instance, raising or lowering the jack 1334 (e.g., which may optionally be a scissor jack) is translated to raising or lowering the flow element 1300H relative to the proximal end 1110 of the controlled flow baffle 114.

By way of another example, as illustrated in FIG. 13I, the flow element 1300I is installed over the proximal end 1110 of the controlled flow baffle 114, and a pneumatic or hydraulic element 1336 is located between the proximal end 1110 of the controlled flow baffle 114 and the flow element 1300I. For instance, the pneumatic or hydraulic element 1336 may include, but is not limited to, an inflatable bag or a cylinder that is in fluid communication with a source of compressed air or incompressible liquid such as a tank or a pump 1338 (e.g., a bulb, compressor, or the like). Increasing or decreasing the pressure within the pneumatic or hydraulic element 1336 raises or lowers the flow element 1300I relative to the proximal end 1110 of the controlled flow baffle 114.

By way of another example, as illustrated in FIG. 13J, the flow element 1300J is installed over or proximate to the proximal end 1110 of the controlled flow baffle 114. The flow element 1300Jmay include a wedge assembly 1340 including at least one wedge 1342, where the wedge 1342 is adjustable to raise or lower the weir crest. For example, the wedge assembly 1340 may include a first fixed wedge 1342A (e.g., which may be integrally formed with or attached to the proximal end 1110 of the controlled flow baffle 114) and a second wedge 1342B that is actuatable, where the second wedge 1342B is coupled to an actuator 1344 via a shaft 1346. In one non-limiting configuration, the wedge 1342B and the shaft 1346 includes complementary threading, such that rotation of the actuator 1344 (e.g., which may be a wheel or lever) causes the shaft 1346 to increase or decrease engagement of threading and draw the wedge 1342B closer to (or push away from) the wedge 1342A. Drawing the wedge 1342Bcloser to the wedge 1342Amay raise the weir crest, while pushing the wedge 1342B away from the wedge 1342A may lower the weir crest.

By way of another example, as illustrated in FIG. 13K, the flow element 1300K is coupled to a worm gear assembly 1348 with a worm gear 1350 and a worm wheel 1352 (e.g., including via an optional hinge or pivot 1354). For instance, with the meshing between the worm gear 1350 and the worm wheel 1352, rotation of the worm wheel 1352 is converted to translation of the worm gear 1350, causing the worm gear 1350 to raise or lower. The flow element 1300K, being coupled to the worm gear 1350, also raises or lowers with the rotation of the worm gear 1350.

By way of another example, as illustrated in FIG. 13L, the flow element 1300L is coupled to one or more jacks (e.g., which may optionally be screw jacks), where the jacks are adjustable to raise or lower the weir crest. For example, the jacks may include a first jack 1356A and a second jack 1356B, where the jacks 1356A, 1356B are coupled to an actuator 1358 via a shaft 1360. In one non-limiting configuration, rotation of the actuator 1358 (e.g., which may be a wheel or lever) causes the shaft 1360 to increase or decrease engagement of threading with one or more of the jacks 1356A, 1356B, raising or lowering the flow element 1300L to adjust the height of the weir crest.

By way of another example, as illustrated in FIG. 13M, the flow element 1300M is a translatable plate that is coupled to a hinged assembly 1362 with a plurality of linkages 1364 that are coupled together via one or more hinges 1366. With the changing of an angle between adjacent linkages 1364, the translatable plate of the flow element 1300M raises or lowers relative to the proximal end 1110 of the controlled flow baffle 114, raising or lowering the height of the weir crest.

By way of another example, as illustrated in FIGS. 13N and 13O, the flow element 1300N comprises a pair of translatable plates 1368A, 1368B with respective apertures 1370A, 1370B that are selectively alignable. More specifically, the apertures 1370A, 1370B may be unaligned, partially align, or fully align depending on the position of plate 1368B relative to 1368A. As alignment of the apertures 1370A, 1370B decreases, flow resistance increases and the weir crest may raise relative to the proximal end 1110 of the controlled flow baffle 114. As alignment of the apertures 1370A, 1370B increases, flow resistance decreases and the weir crest may lower relative to the proximal end 1110 of the controlled flow baffle 114.

In general, any of the means of control for adjustment of the flow element 1300A-1300N may be combinable and/or interchangeable, without departing from the scope of the present disclosure.

It is contemplated that the flow elements 1300A-1300N may be continuously adjustable via automatic or manual means of control (e.g., as illustrated in at least FIG. 2), or may be adjusted to a pre-determined position and then left for passive weir crest transition, without departing from the scope of the present disclosure.

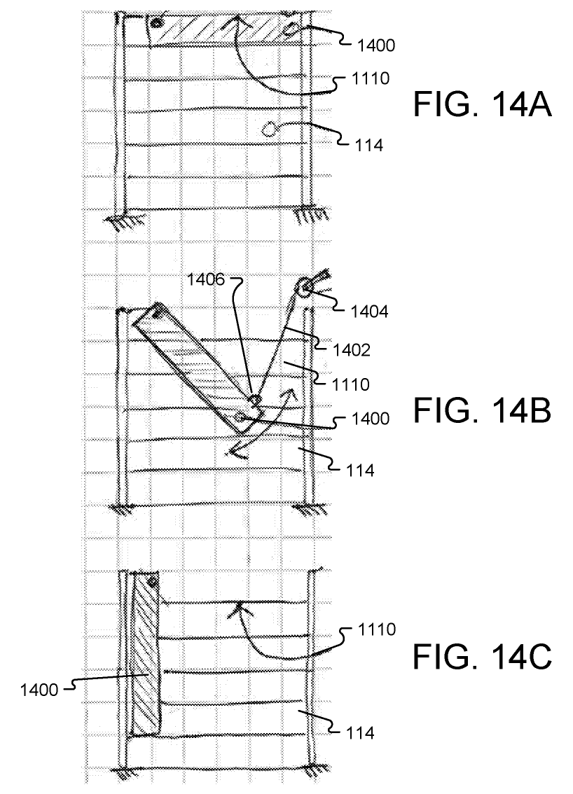

Referring now to FIGS. 14A-14C, a variation of the flow element 201, labelled flow element 1400, is shown with a controlled flow baffle 114. The flow element 1400 is operable as a swing baffle, where the weir crest proximate to the proximal end 1110 of the controlled flow baffle 114 is passively controlled by the flow element 1400 being in a folded or unfolded position. It should be understood that the flow element 1400 may be installable and usable with any treatment system and/or installable on the controlled flow baffle as described throughout the present disclosure, both as standalone flow elements or in combination with other variations of the flow element 201 within the treatment system and/or installable on the controlled flow baffle 114.

In embodiments, the flow element 1400 is coupled to a flexible linkage 1402 of a ratchet 1404 (e.g., including via an optional hinge or pivot 1406). For instance, increasing or decreasing the length of the linkage 1402 via the ratchet 1404 causes the flow element 1400 to open or close. The linkage 1402 may include, but is not limited to, a chain, a strap, or a cable. As illustrated in the transition between the FIG. 14A, FIG. 14B, and FIG. 14C, the flow element 1400 may transition between a first position when in use and a second position when not in use.

Although FIGS. 14A-14C are directed to a ratchet 1404, it should be understood that the ratchet 1404 is only one example of a mechanism usable to increase or decrease the length of the linkage 1402, for purposes of the present disclosure. In general, any mechanism may be implemented that is usable to increase or decrease the length of the linkage 1402.

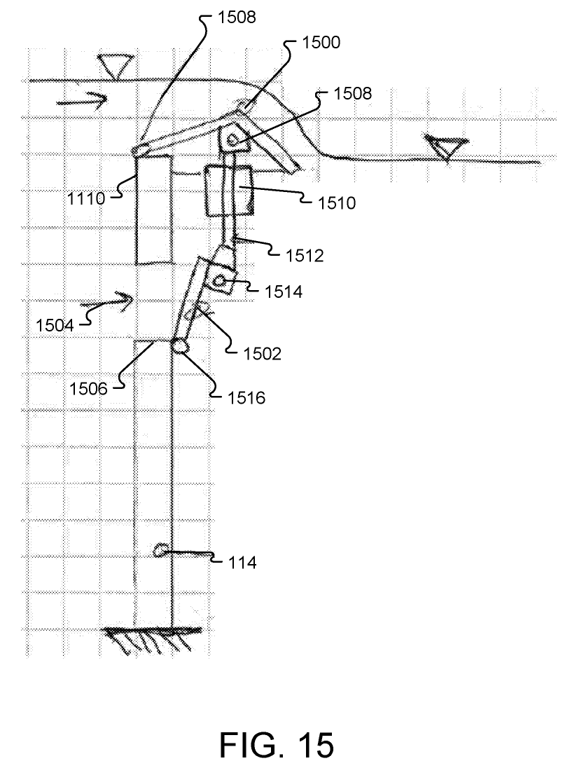

Referring now to FIGS. 15, a variation of the flow element 201 and the actuation element 200, labelled flow element 1500 and actuation element 1502 respectively, is shown with a controlled flow baffle 114. The flow element 1500 and the actuation element 1502 are operable as a flow balance weir and orifice, where flow 1504 through an opening 1506 (or orifice) within the controlled flow baffle 114 and the weir crest that flows over the proximal end 1110 of the controlled flow baffle 114 is passively controlled by the flow element 1500 and the actuation element 1502 being in one of a plurality of positions. It should be understood that the flow element 1500 and the actuation element 1502 may be installable and usable with any treatment system and/or installable on the controlled flow baffle as described throughout the present disclosure, both as standalone flow elements and actuation elements or in combination with other variations of the flow element 201 and actuation element 200 within the treatment system and/or installable on the controlled flow baffle 114.

In embodiments, the flow element 1500 may have any cross-section that is contoured to conform to a particular line including one or more transitions, where surrounding the transitions may be respective pre-transition portions and/or post-transition portions that are set at any angle relative to one another. For example, the general contouring of the cross-section of the flow element 1500 may be selected based on a pre-determined smoothness of transition for the weir crest. The transition may be straight (e.g., with an angle of substantially zero) or may include, but is not limited to, bends or curves that conform to a particular radius of curvature, corners or steps that come to a point, or the like.

In embodiments, the flow element 1500 is coupled to the proximal end 1110 of the controlled flow baffle 114 via a pivot or a hinge 1508. Generally, any exemplary configuration of flow element 1100, 1200, 1300, in combination with the hinge 1508, may be usable as the flow element 1500, without departing from the scope of the present disclosure.

In embodiments, the flow element 1500 is coupled to a float 1510 that raises and lowers with the liquid surface height within the treatment tank. For example, the float 1510 may be located on the post-weir crest side of the controlled flow baffle 114, such that the float 1510 is operable to balance a force of water pushing down on the flow element 1500 after cresting the controlled flow baffle 114. Optionally, the flow element 1500 is coupled to the float 1510 via the hinge 1508, to maintain a particular configuration of the float 1312 within the treatment tank.

The float 1510 is additionally coupled to a linkage 1512, which is coupled to the actuation element 1502. Optionally, the actuation element 1502 is coupled to the linkage 1512 via a hinge 1514, to maintain a particular configuration of the actuation element 1502 relative to the controlled flow baffle 114 and the opening 1506. In some configurations, the actuation element 1502 is pivotably coupled via a hinge 1516 to the controlled flow baffle 114.

With the connectivity between the flow element 1500 and the actuation element 1502, the linkage 1512 actuates to open the actuation element 1502 relative to the opening 1506 when the float 1510 and the flow element 1500 decreases in height as the liquid surface height drops within the treatment tank (or a particular zone associated with the controlled flow baffle 114). Similarly, the linkage 1512 actuates to close the actuation element 1502 relative to the opening 1506 as the liquid surface height raises within the treatment tank (or zone) causing the float 1510 and the flow element 1500 to increase in height. This passively balances the movement of the flow element 1500 with the actuation element 1502 to accommodate changes in flow.

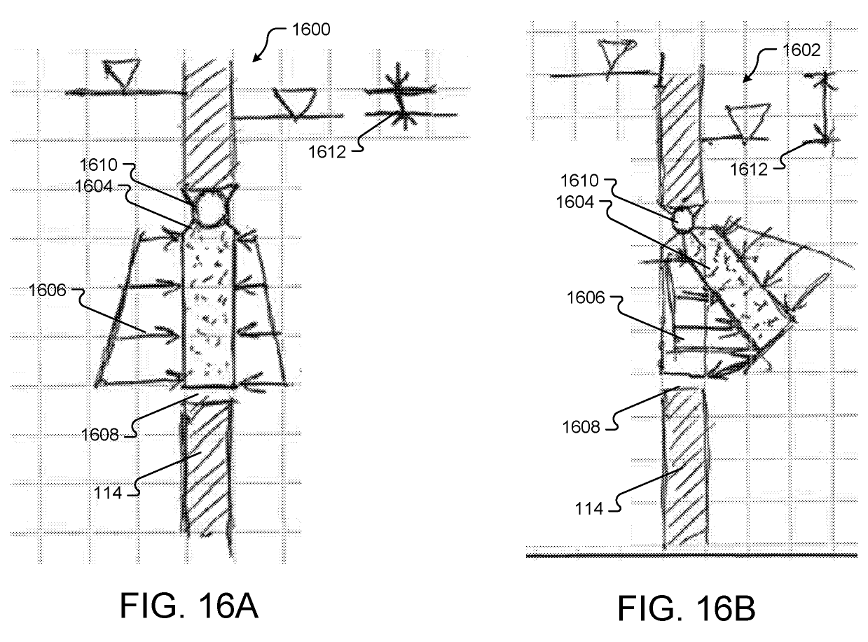

Referring now to FIGS. 16A and 16B, schematics 1600 and 1602 respectively illustrate free-body forces on a variation of the actuation element 200, labelled actuation element 1604, with a particular controlled flow baffle 114. The actuation element 1604 is operable as a flap valve, where flow 1606 through an opening 1608 within the controlled flow baffle 114 is controlled by the opening and closing of the actuation element 1604 (e.g., non-limitingly, via a hinge 1610). It should be understood that the actuation element 1604 may be installable and usable with any treatment system and/or installable on the controlled flow baffle as described throughout the present disclosure, both as standalone actuation elements or in combination with other variations of the actuation element 200 within the treatment system and/or installable on the controlled flow baffle 114.

In the schematic 1600, the minimum flow when the actuation element 1604 is closed (as generally illustrated in FIG. 16A) may be approximately 0.5Q, where Q is a dimensionless unit of flow rate. The difference 1612 in the liquid surface height across the controlled flow baffle may be approximately 1 inch (e.g., which, in some non-limiting examples, may represent a minimum weir depth). In some configurations of the actuation element 1604, a differential pressure in excess of approximately 1 inch of head across the controlled flow baffle 114 may cause the actuation element 1604 to open.

In the schematic 1602, the maximum flow when the actuation element 1604 is open (as generally illustrated in FIG. 16B) may be approximately 3Q. The difference 1612 in the liquid surface height across the controlled flow baffle may be between approximately 2 inches and approximately 2.5 inches (e.g., which, in some non-limiting examples, may represent a maximum weir depth). Optionally, up to 2Q of fluid may be recycled.

Based on comparison between schematics 1600 and 1602, it should be understood that the actuation element 1604 may be able to withstand forces from fluid flow that act on the actuation element 1604 up to a pre-determined threshold for which the actuation element 1604 is configured, allowing the actuation element 1604 to maintain a closed position (or previous partially open position). However, when fluid flow rate exceeds a pre-determined threshold, which runs the risk of overfilling the pre-weir portion of the treatment tank (or zone) amd/or increasing weir crest height over the controlled flow baffle 114 (not shown), the actuation element 1604 opens from the closed position (or opens more from the partially open position) and additional flow 1606 is able to pass through the opening 1608. Similarly, when fluid flow rate reduces to below the pre-determined threshold, the actuation element 1604 returns to the closed position (or to the previous partially open position) and less flow 1606 passes through the opening 1608.

In embodiments, a ratio between the area of the actuation element 1604 and the opening 1608 may range between approximately 0.05 pounds (lbs) per square inch (psi) and 2 psi. As generally discussed with respect to actuation elements 700, 800, 900, the actuation elements 1604 may optionally be weighted.

In embodiments, the actuation element 200 and/or the flow element 201 (and/or any variations as described throughout the present disclosure) may include a biasing element that provides a biasing force to keep the actuation element 200 and/or the flow element 201 in a particular location absent the acting of additional forces on the actuation element 200 and/or the flow element 201. For example, the biasing element may bias the actuation element 200 and/or the flow element 201 toward a full flow or open position. By way of another example, the biasing element may bias the actuation element 200 and/or the flow element 201 to a closed flow or closed position.

In embodiments, the actuation element 200 (and/or any variations as described through the present disclosure) may only partially seal within or against the opening in the controlled flow baffle 114 when in the closed position, such that at least some flow always occurs through the opening in the controlled flow baffle 114. In other embodiments, however, the actuation element 200 (and/or any variations as described through the present disclosure) may fully seal within or against the opening in the controlled flow baffle 114 when in the closed position, such that flow across the controlled flow baffle 114 only occurs as a weir crest over the proximal end 1110 of the controlled flow baffle 114.

In embodiments, the flow element 201 (and/or any variations as described through the present disclosure) may only partially prevent flow over the proximal end 1110 of the controlled flow baffle 114 when in a fully raised position, such that at least some flow always occurs over the proximal end 1110 of the controlled flow baffle 114. In other embodiments, however, the flow element 201 (and/or any variations as described through the present disclosure) may fully prevent flow over the proximal end 1110 of the controlled flow baffle 114 when in a fully raised position, such that flow across the controlled flow baffle 114 only occurs through the opening in the controlled flow baffle 114.

In general, the actuation elements 200 and/or flow elements 201 (and variations thereof) may be operated by any number of combined active (e.g., automated and/or manual) means of control or passive means of control, without departing from the scope of the present disclosure. In addition, the actuation elements 200 and/or flow elements 201 (and variations thereof) may be individually controllable via active and/or passive means, and/or may be controlled in groups or subsets (including optionally as a single collective) via active and/or passive means, without departing from the scope of the present disclosure.

In embodiments, the actuation elements 200 and/or flow elements 201 (and variations thereof) may be considered to be adjustable in a number of configurations (or positions) depending on one or more of fluid flow rate, fluid pressure, liquid surface height, and other operational parameters within the treatment tank or treatment system. For example, a closed position for an actuation element 200 and/or a flow element 201 may be considered a closed configuration, and vice versa, for purposes of the present disclosure. By way of another example, an open position for an actuation element 200 and/or a flow element 201 may be considered an open configuration, and vice versa, for purposes of the present disclosure. In general, any position of an actuation element 200 and/or a flow element 201 may be considered a configuration that is adjusted or adjustable in response to parameters within the treatment system or treatment tank, for purposes of the present disclosure.

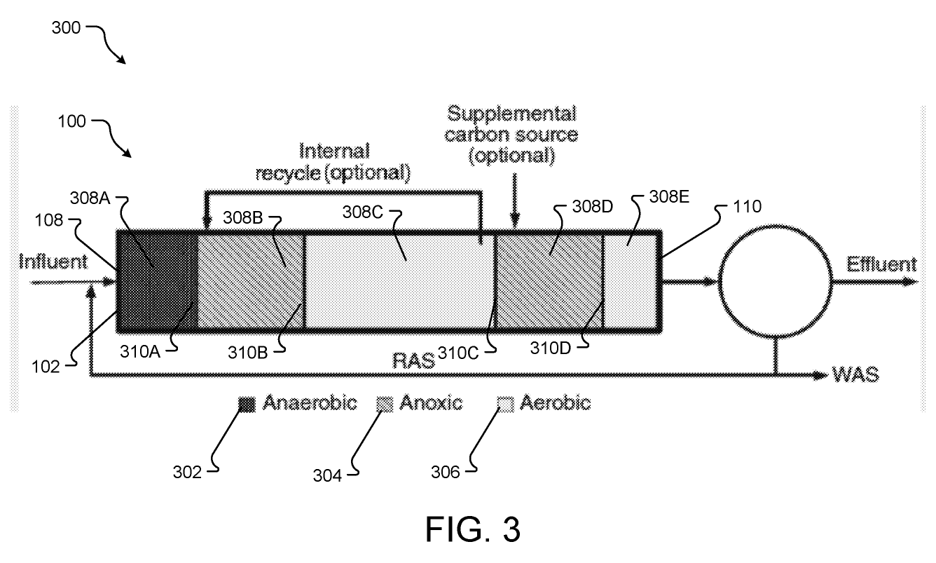

FIG. 3 illustrates an example of the treatment system 100 with treatment tank 102 including controlled flow baffles 310 (which are the same as or similar to controlled flow baffles 114), where the treatment system 100 is operable to perform a wastewater treatment process 300, in accordance with one or more embodiments of the present disclosure. In particular, FIG. 3 illustrates a five-stage Bardenpho treatment process 300, which is a biological nutrient removal (BNR) system with five distinct stages that each provide specific conditions to encourage a desired microbial activity for nutrient removal.

In embodiments, the five-stage Bardenpho treatment process 300 includes an anaerobic stage 302, two anoxic stages 304, and two aerobic stages 306. Adjacent zones 308 are separated by the controlled flow baffles 310. It should be understood that the zones 308 and the zones 112 may be considered equivalent and interchangeable, and that the controlled flow baffles 310 and the controlled flow baffles 114 as described herein may be considered interchangeable, without departing from the scope of the present disclosure. Further, the controlled flow baffles 310 may include one or more actuation elements 201 and flow through baffle openings or ports 204 generally illustrated in FIG. 2.

Influent (e.g., the inlet flow of water or wastewater) enters, via an inlet 108, into a first zone 308A that includes an anaerobic stage 302. In the first zone 308A and the anaerobic stage 302, bacteria release phosphorus from cells due to lack of oxygen and create a phosphorus-rich fluid.

A first controlled flow baffle 310A separates the first zone 308A and a second zone 308B including a first anoxic process 304. The first anoxic process 304 in the second zone 308B includes a low-oxygen environment where denitrifying bacteria use the released phosphorus as an electron donor to remove nitrate.

A second controlled flow baffle 310B separates the second zone 308B and a third zone 308C including a first aerobic process 306. The first aerobic process 306 is a fully aerated stage where bacteria oxidizes organic matter and simultaneously converts ammonia to nitrite and nitrate. Optionally, an internal recycling step can occur from the third zone 308C and the second zone 308B, including to remove the formed nitrite and/or nitrate.

A third controlled flow baffle 310C separates the third zone 308C and a fourth zone 308D including a second anoxic process 304. The second anoxic process 304 is a low-oxygen zone where the previously-produced nitrate is converted to nitrogen gas by denitrifying bacteria. Optionally, carbon (e.g., in the form of methanol) may be supplied in the fourth zone 308D is assist in the conversion process.

A fourth controlled flow baffle 310D separates the fourth zone 308D and a fifth zone 308E including a second aerobic process 306. The second aerobic process 306 is another aeration stage to ensure complete oxidation of organic matter and further nutrient removal. The resultant treated wastewater exits the treatment tank 102 via the outlet 110.

After exiting the treatment tank 102, the treated wastewater may be processed in a clarifier. Optionally, a portion of the treated wastewater that is waste-activated sludge (WAS) may be removed from the clarifier, and/or a portion of the treated wastewater that is return-activated sludge (RAS) may be sent back from the clarifier to mix with the influent to make another pass through the treatment tank 102 and the five-stage Bardenpho treatment process 300 performed therein. The remainder of the treated wastewater that is not WAS or RAS exits the clarifier as effluent.

By controlling the oxygen levels in each stage, the five-stage Bardenpho treatment process 300 efficiently removes both nitrogen and phosphorus from wastewater. While the five-stage Bardenpho treatment process 300 can require multiple tanks to isolate the different zones (and specific oxygen contents therein), it is possible to instead perform the stages of the five-stage Bardenpho treatment process 300 in zones 308A, 308B, 308C, 308D, 308E separated by controlled flow baffles 310A, 310B, 310C, 310D.

Although not shown, it should be understood that the wastewater flows over the controlled flow baffles 310, and additionally optionally through openings or ports 204 (not shown) within the controlled flow baffles 310 (e.g., in a manner the same or substantially similar to that generally illustrated in FIG. 2). To further increase the efficiency of the treatment process 300, adjusting the position of the actuation elements 200 (not shown) in one or more of the controlled flow baffles 310A, 310B, 310C, 310D allows for the maintaining of a controlled weir crest for the wastewater which passes between the adjacent zones 308A, 308B, 308C, 308D, 308E over the controlled flow baffles 310A, 310B, 310C, 310D. It is noted that some benefits of maintaining a controlled weir crest between the upstream and downstream sides of a zone partition in a five-stage Bardenpho activated sludge reactor configuration include preventing the accumulation or trapping of floating material, and preventing back mixing (e.g., between an aerated zone and an upstream unaerated zone).

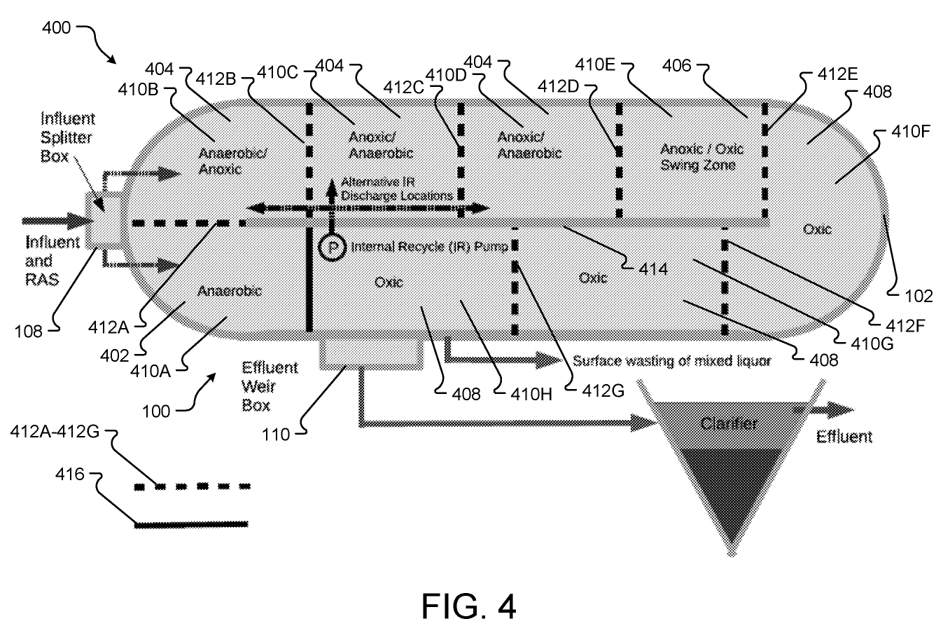

FIG. 4 illustrates an example of the treatment system 100 with treatment tank 102 including controlled flow baffles 412 (which are the same as or similar to controlled flow baffles 114), where the treatment system 100 is operable to perform a wastewater treatment process 400, in accordance with one or more embodiments of the present disclosure. In particular, FIG. 4 illustrates an oxidation ditch or closed loop reactor treatment process 400.

In embodiments, the oxidation ditch or closed loop reactor 400 includes one or more anaerobic stages 402, one or more anaerobic/anoxic stages 404, one or more anoxic/oxic swing zone stages 406, and/or one or more oxic stages 408. In some configurations, the anaerobic/anoxic stages 404 may include vertical mixing systems such as compressed gas mixing, low-pressure air large bubble mixing, or other mixing systems that do not produce horizontal flow conditions. In some configurations, the oxic stages 408 may include vertical mixing systems in addition to fine bubble diffused aeration systems.

In embodiments, adjacent zones 410 are separated by the controlled flow baffles 412. It should be understood that the zones 410 and the zones 112 as described herein may be considered interchangeable, and that the controlled flow baffles 412 and the controlled flow baffles 114 as described herein may be considered interchangeable, without departing from the scope of the present disclosure.

Influent (e.g., the inlet flow of water or wastewater optionally combined with return-activated sludge, or RAS) enters into an influent splitter box at an inlet 108 of the treatment tank 102. RAS enters an aerobic stage 402 in a zone 410A. The influent enters a first anaerobic/anoxic stage 404 in a zone 410B, which is separated from the zone 410A by a controlled flow baffle 412A.

A second controlled flow baffle 412B separates the second zone 410B and a third zone 410C including a second anaerobic/anoxic stage 404. A third controlled flow baffle 412C separates the third zone 410C and a fourth zone 410D including a third anaerobic/anoxic stage 404.

A fourth controlled flow baffle 412D separates the fourth zone 410D and a fifth zone 410E including the anoxic/oxic swing zone stage 406. A fifth controlled flow baffle 412E separates the fifth zone 410E and a sixth zone 410F including a first oxic stage 408.

A sixth controlled flow baffle 412F separates the sixth zone 410F and a seventh zone 410G including a second oxic stage 408. A seventh controlled flow baffle 412G separates the seventh zone 410G and an eighth zone 410H including a third oxic stage 408. Optionally, internal recycling can occur from the eighth zone 410H through a divider 414 within the treatment tank 102 into the zones 410B, 410C, and/or 410D including the first, second, and/or third anaerobic/anoxic stages 404 respectively. In some configurations, the eighth zone 410H and the first zone 410A are separated by a physical wall 416 (e.g., which may be a controlled flow baffle 412 that has the actuation elements 200 (not shown) in a permanently shut or closed position).

The resultant treated wastewater exits the treatment tank 102 via the outlet 110 (e.g., a weir box). After exiting the treatment tank 102, the treated wastewater may be processed in a clarifier. Optionally, a portion of the treated wastewater that is waste-activated sludge (WAS) may be removed from the eighth zone 410H, and/or a portion of the treated wastewater that is return-activated sludge (RAS) may be sent back (e.g., from the clarifier) to mix with the influent to make another pass through the treatment tank 102 and the oxidation ditch or closed loop reactor treatment process 400 performed therein. The remainder of the treated wastewater that is not WAS or RAS exits the clarifier as effluent.

While the oxidation closed loop reactor treatment process 400 can require multiple tanks to isolate the different zones (and specific oxygen contents therein), it is possible to instead perform the stages of the oxidation ditch or closed loop reactor treatment process 400 in zones 410A, 410B, 410C, 410D, 410E, 410F, 410G, 410H separated by controlled flow baffles 412A, 412B, 412C, 412D, 412E, 412F, 412G.

Although not shown, it should be understood that the wastewater flows over the controlled flow baffles 412, and additionally optionally through openings or ports 204 (not shown) within the controlled flow baffles 412. To further increase the efficiency of the oxidation ditch or closed loop reactor treatment process 400, operating actuation elements 200 (not shown) in one or more of the controlled flow baffles 412A, 412B, 412C, 412D, 412E, 412F, 412G allows for the maintaining of a controlled weir crest for the wastewater passes between the adjacent zones 410A, 410B, 410C, 410D, 410E, 410F, 410G, 410H over the controlled flow baffles 412A, 412B, 412C, 412D, 412E, 412F, 412G. It is noted that some benefits of maintaining a relatively constant and appropriate weir crest (or drop) between the upstream and downstream sides of a zone partition in an oxidation ditch activated sludge reactor configuration include preventing the accumulation or trapping of floating material and to prevent back mixing (e.g., between an aerated zone and an upstream unaerated zone).

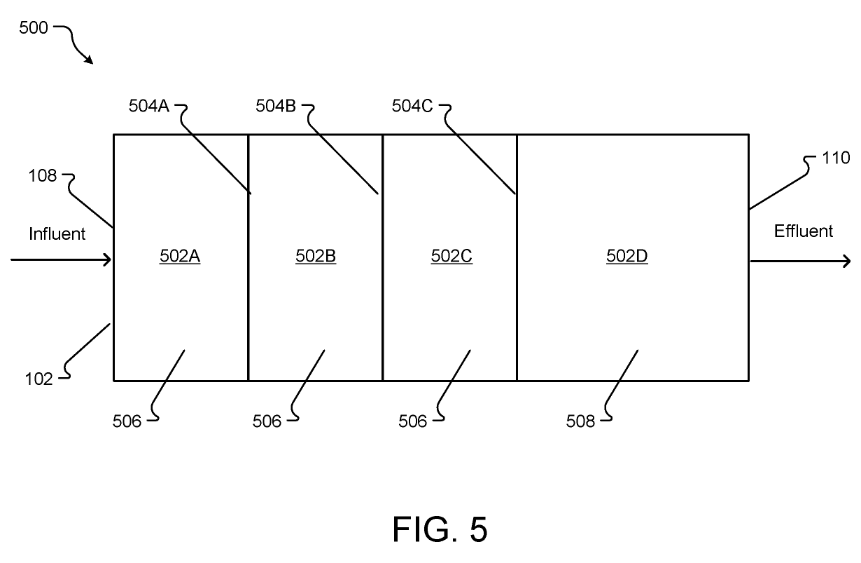

FIG. 5 illustrates an example of the treatment system 100 with treatment tank 102 including controlled flow baffles 504 (which are the same as or similar to controlled flow baffles 114), where the treatment system 100 is operable to perform a water treatment process 500, in accordance with one or more embodiments of the present disclosure.

In embodiments, the treatment process 500 includes adjacent zones 502 separated by the controlled flow baffles 504. It should be understood that the zones 502 and the zones 112 may be considered equivalent and interchangeable, and that the controlled flow baffles 504 and the controlled flow baffles 114 as described herein may be considered interchangeable, without departing from the scope of the present disclosure.

Influent (e.g., the inlet flow of water or wastewater) enters, via an inlet 108, into a first zone 502A. For example, the influent may be coagulated influent prior to entry into a first flocculation stage 506 in a first zone 502A.

A first controlled flow baffle 504A separates the first zone 502A and a second zone 502B, which includes a second flocculation stage 506. In addition, a second controlled flow baffle 504B separates the second zone 502B and a third zone 502C, which includes a third flocculation stage 506. Further, a third controlled flow baffle 504C separates the third zone 502C and a fourth zone 502D. In some configurations, the fourth zone 502D optionally includes a sedimentation stage 508.

The resultant treated water exits the treatment tank 102 via the outlet 110. The treated water is typically further treated using a solids separation or filtration process prior to other potable water related post processing.

While the treatment process 500 can require multiple tanks to isolate the different zones, it is possible to instead perform the stages of the treatment process 500 in zones 502A, 502B, 502C, 502D separated by controlled flow baffles 504A, 504B, 504C.

Although not shown, it should be understood that the water flows over the controlled flow baffles 504, and additionally optionally through openings or ports 204 (not shown) within the controlled flow baffles 504. To further increase the efficiency of the treatment process 500, adjusting the position of the actuation elements 200, 201 (not shown) in one or more of the controlled flow baffles 504A, 504B, 504C allows for the maintaining of a controlled weir crest for the wastewater which passes between the adjacent zones 502A, 502B, 502C, 502D over the controlled flow baffles 504A, 504B, 504C.

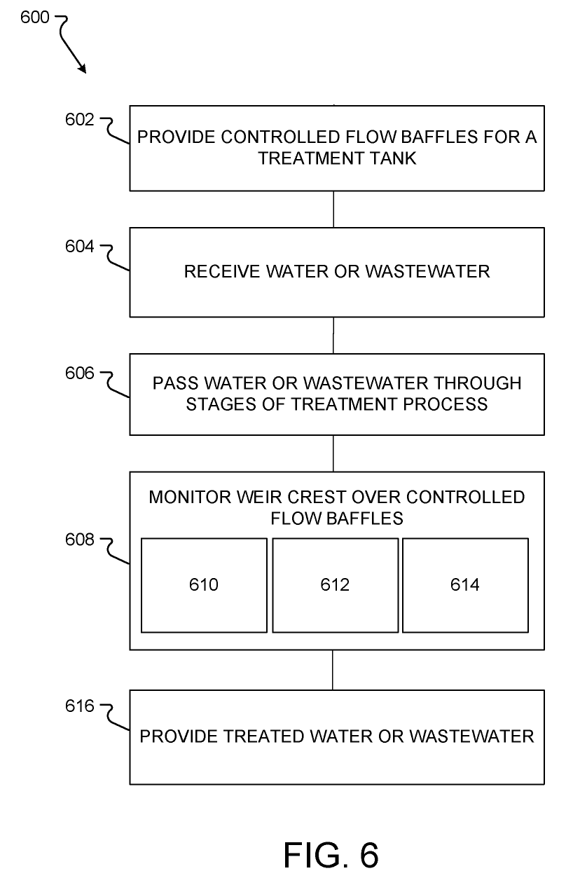

FIG. 6 is a flow diagram of a method or process 600 illustrating a method of using controlled flow baffles 114 within a treatment tank 102, in accordance with one or more embodiments of the present disclosure. While a general order for the actions of the method or process 600 is shown in FIG. 6, the method or process 600 can include more or fewer actions or can arrange the order of the actions differently (including simultaneously, substantially simultaneously, or sequentially) than those shown in FIG. 6. It is noted that the method or process 600 shall be explained with reference to the components, devices, subassemblies, environments, etc. described in conjunction with FIGS. 1-5. For example, it is noted that the embodiments as illustrated in FIGS. 1-5 should be understood as reading on the embodiments described with respect to FIG. 6, and vice versa, without departing from the scope of the present disclosure.

In embodiments, controlled flow baffles for a treatment tank are provided 602. The treatment tank 102 includes a plurality of controlled flow baffles 114 that separate the cavity 106 defined within the treatment tank 102 into a plurality of zones 112. In some configurations, the controlled flow baffles 114 can include actuation elements 200 that increase or decrease a size of an opening or port 204 within the particular controlled flow baffle 114. In other configurations, the controlled flow baffles 114 can include actuation elements 201, alternatively or in addition to the actuation elements 200, that adjust the height of a weir relative to the liquid surface.

In embodiments, water or wastewater is received 604. For example, water or wastewater in need of treatment may enter into a first zone 112 of a treatment tank 102 via an inlet 108, which is either a pre-treatment stage or includes the first stage of a treatment process performed within the treatment tank 102.

In embodiments, the water or wastewater is passed 606 through stages of a treatment process. The water or wastewater passes over successive controlled flow baffles 114 between adjacent zones 112, and is subjected to a particular stage of the treatment process within each particular zone 112. Optionally, the water or wastewater flows through openings within respective controlled flow baffles 114 between adjacent zones 112, where actuation elements 200 within the respective controlled flow baffles 114 are open.

In embodiments, a weir crest of the water or wastewater is monitored 608. The weir crest is above-surface, passing over the controlled flow baffles 114, while the actuation elements 200 are subsurface or below-surface and/or the actuation elements 201 are proximate to the liquid surface. Data from sensors 214 may be provided to a control unit 216 of a control system 212, to assist in monitoring an elevation of the weir crest over the controlled flow baffles 114. When the weir crest is not at a pre-determined threshold (or within a range of pre-determined thresholds), in some embodiments a user may actively and manually adjust the actuation elements 200 and/or 201 of one or more of the controlled flow baffles 114. Alternatively or in addition, when the weir crest is not at a pre-determined threshold (or within a range of pre-determined thresholds), the control unit 216 may actively and automatically adjust the actuation elements 200 and/or 201 of one or more of the controlled flow baffles 114. Further, when the weir crest is not at a pre-determined threshold (or within a range of pre-determined thresholds), the actuation elements 200 and/or 201 may be passively adjusted by forces associated with flow-induced head loss, buoyancy forces, or other means not requiring actuation by operator or controller. It is noted that any combination of passive and active (e.g., automatic and/or manual) adjustments may occur, without departing from the scope of the present disclosure.

For example, if the weir crest exceeds a pre-determined threshold, the actuation elements 200 may be adjusted (or opened) 610 to increase the size of the openings or ports 204 in the controlled flow baffle subsurface and reduce the weir crest elevation. By way of another example, if the weir crest is below a pre-determined threshold, the actuation elements 200 may be adjusted 612 (or closed) to decrease the size of the openings or ports 204 in the controlled flow baffle subsurface and increase the weir crest elevation. By way of another example, a height of a surface weir may be adjusted 614 (e.g., through actuation of the actuation element 201) to increase or reduce the weir crest 206 for the particular controlled flow baffle 114 to be above, at, or below the elevation of the liquid surface. It is noted that some combination of the adjusting 610, 612, 614 may occur, without departing from the scope of the present disclosure.

In embodiments, treated water or wastewater is provided 616. Following passage through the treatment tank 102 and the stages of the treatment process performed within the treatment tank 102, the treated water or wastewater exits the treatment tank 102 via the outlet 110.

Advantages of the present disclosure include controlled flow baffles for a treatment tank. The treatment tank receives water or wastewater in need of treatment, and outputs treated water or wastewater. During treatment, the received water or wastewater is subjected to one or more stages of a water or wastewater treatment process within the treatment tank. The treatment tank includes zones defined by the controlled flow baffles, where the various stages of the water or wastewater treatment process are isolated to one or more defined zones. To maintain a desired (e.g., controlled) weir crest over the controlled flow baffles, the controlled flow baffles include actuation elements and/or flow elements that may be actuated to open and close openings within the controlled flow baffles and/or adjust a proximal end of the controlled flow battles to maintain a predetermined weir elevation of the weir crest. The actuation elements and/or flow elements are driven by a control mechanism, which may be passive in operation and/or which may be operated in response to manual controls and/or automatic controls from a control system.

In this regard, the treatment tank with controlled flow baffles provides an improved way to ensure proper fluid flow characteristics through the various stages of a treatment process in zones defined within a treatment tank. Where the above-surface weir crest is too low or too high or otherwise not at the desired elevation, actuation elements subsurface or below surface may be adjusted to modify the above-surface weir crest elevation. The adjustment may occur manually by a user, and/or automatically by a control unit, including based on data received from sensors of a control system. Alternatively, or in addition, the adjustment may occur passively based on operational parameters including, but not limited to, flow conditions within the treatment tank.

While various embodiments of the present disclosure have been described in detail, it is apparent that modifications and alterations of those embodiments will occur to those skilled in the art. However, it is to be understood that such modifications and alterations are within the scope and spirit of the present disclosure, as set forth in the following claims. Further, the invention(s) and aspect(s) described herein is capable of other embodiments and of being practiced or of being carried out in various ways. It is to be understood that the phraseology and terminology used herein is for the purpose of description and should not be regarded as limiting.

What is claimed is:

1. A controlled flow baffle in a treatment tank for water or wastewater treatment, the controlled flow baffle comprising:
an opening defined within a surface of the controlled flow baffle, the opening operable to allow water or wastewater to flow between adjacent zones defined by the controlled flow baffle in the treatment tank; and
an actuation element able to adjust a size of the opening,
wherein increasing the size of the opening by actuating the actuation element increases a flow of the water or wastewater through the opening and decreases an elevation of a weir crest of the water or wastewater flowing over the controlled flow baffle, and
wherein decreasing the size of the opening by actuating the actuation element decreases the flow of the water or wastewater through the opening and increases the elevation of the weir crest of the water or wastewater flowing over the controlled flow baffle.

2. The controlled flow baffle of claim 1, wherein the actuation element is passively controlled by forces associated with flow-induced head loss, buoyancy forces, or other non-actively controlled means.

3. The controlled flow baffle of claim 2, wherein a configuration of the actuation element adjusts in response to a change in liquid surface height within the treatment tank.

4. The controlled flow baffle of claim 2, wherein a configuration of the actuation element adjusts in response to a change in flow rate through the treatment tank.

5. The controlled flow baffle of claim 1, further comprising:
a flow element positioned proximate to a top edge or surface of the controlled flow baffle for increasing or reducing a weir crest for the controlled flow baffle.

6. The controlled flow baffle of claim 5, wherein the flow element is a static flow element.

7. The controlled flow baffle of claim 5, wherein the flow element is passively controlled by forces associated with flow-induced head loss, buoyancy forces, or other non-actively controlled means.

8. The controlled flow baffle of claim 7, wherein a configuration of the flow element adjusts in response to a change in liquid surface height within the treatment tank.

9. The controlled flow baffle of claim 7, wherein a configuration of the flow element adjusts in response to a change in flow rate through the treatment tank.

10. A treatment system for water or wastewater treatment, the treatment system comprising:
a treatment tank, comprising:
an inlet able to receive water or wastewater in need of treatment;
an outlet able to provide treated water or wastewater; and
a controlled flow baffle between the inlet and the outlet, the controlled flow baffle comprising:
an opening defined within a surface of the controlled flow baffle, the opening operable to allow received water or wastewater to flow between adjacent zones defined by the controlled flow baffle in the treatment tank; and
an actuation element able to adjust a size of the opening,
wherein increasing the size of the opening by actuating the actuation element increases a flow of the received water or wastewater through the opening and decreases an elevation of a weir crest of the water or wastewater flowing over the controlled flow baffle, and
wherein decreasing the size of the opening by actuating the actuation element decreases the flow of the received water or wastewater through the opening and increases the elevation of the weir crest of the water or wastewater flowing over the controlled flow baffle.

11. The treatment system of claim 10, further comprising:
a control system; and
a sensor within the treatment tank to monitor operational parameters within the treatment tank, wherein data from the sensor is provided to a control unit of the control system.

12. The treatment system of claim 10, wherein the actuation element is passively controlled by forces associated with flow-induced head loss, buoyancy forces, or other means not requiring actuation by a user or a control system.

13. The treatment system of claim 12, wherein a configuration of the actuation element adjusts in response to a change in liquid surface height within the treatment tank.

14. The treatment system of claim 12, wherein a configuration of the actuation element adjusts in response to a change in flow rate through the treatment tank.

15. The treatment system of claim 10, wherein the controlled flow baffle further comprises:
a flow element positioned proximate to a top edge or surface of the controlled flow baffle for increasing or reducing a weir crest for the controlled flow baffle.

16. The treatment system of claim 15, wherein the flow element is a static flow element.

17. The treatment system of claim 15, wherein the flow element is passively controlled by forces associated with flow-induced head loss, buoyancy forces, or other non-actively controlled means.

18. The treatment system of claim 17, wherein a configuration of the flow element adjusts in response to a change in liquid surface height within the treatment tank.

19. The treatment system of claim 17, wherein a configuration of the flow element adjusts in response to a change in flow rate through the treatment tank.

20. A controlled flow baffle in a treatment tank for water or wastewater treatment, the controlled flow baffle comprising:
an opening defined within a surface of the controlled flow baffle, the opening operable to allow water or wastewater to flow between adjacent zones of the treatment tank defined by the controlled flow baffle;
an actuation element able to adjust a size of the opening, wherein the actuation element is passively controlled by forces associated with flow-induced head loss, buoyancy forces, or other non-actively controlled means; and
a flow element positioned proximate to a top edge or surface of the controlled flow baffle for increasing or reducing a height of a weir crest for the controlled flow baffle.
